(19) United States
(12) Patent Application Publication
(10) Pub. No.: US 2017/0130901 A1
(43) Pub. Date: May 11, 2017

(54) FUEL REFILLING SYSTEMS AND METHODS

(71) Applicant: Agility Fuel Systems, Inc., Fontana, CA (US)

(72) Inventors: Todd F. Sloan, Kelowna (CA); Chris Forsberg, Kelowna (CA); Christopher E. Cannon, Alexandria, AL (US); Dursun Moore, Los Angeles, CA (US); Sean Stevens, Upland, CA (US)

(21) Appl. No.: 15/345,454

(22) Filed: Nov. 7, 2016

Related U.S. Application Data
(60) Provisional application No. 62/253,062, filed on Nov. 9, 2015.

(51) Int. Cl. F17C 5/06; F17C 13/02

(52) U.S. Cl. CPC F17C 5/06; F17C 13/026; F17C 2221/033; F17C 2227/0337; F17C 2250/032; F17C 2270/0581

(57) ABSTRACT

A fuel refilling system may comprise a fueling station, a fuel tank, and a recirculation module in selective fluid communication with one another. The fuel refilling system may comprise a control module configured to generate one or more signals for controlling flow rates of the fuel into and out of the fuel tank, so as to remove and direct a first portion of heated fuel from the fuel tank to the recirculation module, and replace the first portion of heated fuel that is removed from the fuel tank with incoming cooler fuel received from the fueling station and/or the recirculation module. Convective mixing of the cooled fuel with the remaining heated fuel in the fuel tank may cause a temperature of the fuel mixture in the fuel tank to reduce. Accordingly, a filling capacity of the fuel tank may be increased as a result of the temperature reduction in the fuel mixture in the fuel tank.

### CROSS-REFERENCE

This application claims the benefit of U.S. Provisional Application No. 62/253,062 filed Nov. 9, 2015, which is incorporated herein by reference in its entirety.

### BACKGROUND

Natural gas is a consideration as an alternative fuel for vehicles. In a natural gas-powered vehicle, a container or fuel tank is used to hold and transport the natural gas for the vehicle. Such tanks need to be refilled. A desirable fill-range for a natural gas vehicle may be difficult to obtain due to heat of gas compression in compressed natural gas (CNG) fueling systems, which can reduce the capacity utilization of the fuel tank.

### SUMMARY

A need exists for reducing the heat of compression and/or increasing the capacity utilization of a fuel tank.

The capacity utilization of a fuel tank relates to the amount of fuel that can be safely dispensed into the tank, and is a measure of how ‘full’ the tank is filled relative to its rated tank capacity. For example, a fill capacity utilization of 100% means that the fuel tank is completely full, whereas a fill capacity utilization of 75% indicates that the fuel tank is only 75% full (i.e., 75% of its rated tank capacity). The rated tank capacity depends on the rated pressure and temperature of the fuel tank. Fuel tanks are manufactured having different dimensions, shapes, materials, and structures to store different fuel types, all of which affect the rated temperature and pressure of the fuel tank. When a fuel tank is filled with natural gas at a high pressure, the temperature of the gas in the tank typically increases beyond ambient temperatures due to heat of compression. The heat of compression reduces the amount of fuel that can be safely dispensed into the fuel tank, especially in warm climates where ambient temperatures are high. On a warm day, the heat of compression is not easily dissipated to the outside environment because of the high ambient temperatures. At higher temperatures, the natural gas is less dense due to pressure constraints of the cylinder, and therefore does not contain as much combustible energy per unit volume as it would at a lower temperature. As the tank cools to ambient temperature levels, the pressure in the tank can drop below the rated temperature-compensated pressure, thus creating an under-filled condition that reduces driving range for the customer. In some cases, the fuel tank may only achieve a fill capacity utilization of 75% or less.

To compensate for the pressure drop, some fast-fill type compressed natural gas fuel stations may fill a fuel tank above the temperature-compensated pressure for the given ambient condition to over-pressurize the tank, so that the tank pressure can settle to the appropriate temperature-compensated pressure after cooling. However, over-pressurization alone has limitations and will not maximize cylinder capacity utilization for all ambient conditions. For example, on a hot day cylinder capacity utilization can be 75% or lower even when using over-pressurization as a technique for improving capacity utilization. Thus, there is a need for improved systems, methods, and apparatuses for improving the capacity utilization and thermal management of fuel tanks, particularly compressed natural gas fuel tanks.

Aspects of the invention provide improved methods, systems, and devices for filling fuel tanks. In particular, improved methods, systems, and devices are provided for reducing temperature as a fuel tank is being filled, so as to increase capacity utilization of the fuel tank. According to some embodiments, a fuel refilling system may be provided. The fuel refilling system may comprise a fueling station, a fuel tank, and a recirculation module in selective fluid communication with one another, wherein the fuel tank is configured to be filled with a fuel provided by the fueling station. The fuel refilling system may further comprise a control module configured to: (1) generate a first signal for removing a portion of heated fuel from the fuel tank to the recirculation module, and (2) generate a second signal for replacing the removed portion of heated fuel with incoming ambient temperature or sub-ambient temperature fuel from the fueling station. Convective mixing of the ambient temperature fuel with the remaining heated fuel in the fuel tank, coupled with substantially high incoming/outgoing mass flow rates, may cause a temperature of the fuel mixture in the fuel tank to reduce. The capacity utilization of the fuel tank can be increased as a result of the temperature reduction in the fuel mixture in the fuel tank. Such methods, systems, and devices are particularly suitable for compressed natural gas (CNG) fueling systems and fuel tanks, but may also be suitable for other gaseous fuels, including hydrogen or hydrogen-based gases, hythane, HCNG, syngas, alternative fuels of fuel blends, nitrogen bottles, helium, argon, carbon dioxide, producer gas, propane, ethane, methane, and/or biogas, and their fuel tanks.

A fuel refilling system is provided in accordance with an aspect of the invention. The fuel refilling system may comprise a fueling station, a fuel tank, and a recirculation module in selective fluid communication with one another. The fuel tank may be configured to be filled with a fuel provided by the fueling station. The fuel refilling system may further comprise a control module configured to generate one or more signals for controlling flow rates of the fuel into and out of the fuel tank, so as to remove and direct a first portion of heated fuel from the fuel tank to the recirculation module, and replace the first portion of heated fuel that is removed from the fuel tank with incoming cooler fuel received from the fueling station and/or the recirculation module.

In another aspect of the invention, a method of filling a fuel tank may comprise configuring the fuel tank, a fueling station, and a recirculation module to be in selective fluid communication with one another. The fuel tank may be configured to be filled with a fuel provided by the fueling station. The method may also comprise generating, via a control module with aid of a processor, one or more signals for controlling flow rates of the fuel into and out of the fuel tank, to thereby (1) remove and direct a first portion of heated fuel from the fuel tank to the recirculation module, and (2) replace the first portion of heated fuel that is removed from the fuel tank with incoming cooler fuel from the fueling station and/or the recirculation module.

According to a further aspect of the invention, a non-transitory computer-readable medium is provided with instructions stored thereon that, when executed by a control module with aid of a processor, causes the control module to perform a method of filling a fuel tank. The method performed by the control module may comprise configuring the fuel tank, a fueling station, and a recirculation module to be in selective fluid communication with one another. The fuel tank may be configured to be filled with a fuel provided by the fueling station. The method may also comprise generating one or more signals for controlling flow rates of the fuel into and out of the fuel tank, to thereby (1) remove and direct a first portion of heated fuel from the fuel tank to the recirculation module, and (2) replace the first portion of heated fuel that is removed from the fuel tank with incoming cooler fuel from the fueling station and/or the recirculation module.

In some embodiments, a capacity utilization of the fuel tank may be increased as a result of temperature reduction within the fuel tank caused by convective mixing of the incoming cooler fuel with a remaining portion of the heated fuel. The fuel may include compressed natural gas (CNG), and the fueling station may be selected from the group consisting of a direct fill CNG station and a cascade CNG station. The fueling station, the fuel tank, and the recirculation module may be in selective fluid communication with one another in a closed loop configuration.

In some embodiments, the recirculation module may include a heat exchanger configured to cool the first portion of heated fuel. The recirculation module may also include a compressor configured to compress the cooled first portion of fuel. The recirculation module may be configured to direct the compressed and cooled first portion of fuel to the fueling station and/or the fuel tank.

In some embodiments, the control module may be configured to generate the one or more signals based on sensing data collected by a plurality of sensors located at different junctures of the fuel refilling system. The plurality of sensors may comprise mass flow sensors, temperature sensors, and/or pressure sensors. The fuel refilling system may comprise (1) one or more inlet pipes leading into the fuel tank and (2) an outlet pipe leading out of the fuel tank. The one or more signals may comprise (1) a first signal that causes one or more inlet flow control valves along the one or more inlet pipes to open to a first degree, and (2) a second signal that causes an outlet flow control valve along the outlet pipe to open to a second degree. The first degree and the second degree may be different. The first degree and the second degree may be dynamically adjustable in order to vary incoming and outgoing fuel flow rates to/from the fuel tank, such that the fuel tank is capable of being filled within a predetermined time period, while controlling and/or reducing temperature rise due to heat of compression in the fuel tank during the filling. The one or more inlet pipes may include (i) a first inlet pipe connecting the fuel tank to the fueling station and (ii) a second inlet pipe connecting the fuel tank to the recirculation module. The incoming cooler fuel may be directed to the fuel tank (i) from the fueling station through the first inlet pipe, and/or (ii) from the recirculation module through the second inlet pipe. The outlet pipe may connect the fuel tank to the recirculation module. The first portion of heated fuel may be removed from the fuel tank and directed to the recirculation module through the outlet pipe. The second signal may be generated when one or more temperature sensors detect a temperature of the fuel in the fuel tank exceeding a predetermined threshold temperature. The predetermined threshold temperature may correspond to a Joule-Thomson temperature achieved within the fuel tank. The first degree and the second degree may be adjustable in order to generate forced convective mixing of the incoming cooler fuel with the remaining portion of the heated fuel, so as to increase a level of turbulence of the fuel mixture within the fuel tank.

Additional aspects and advantages of the disclosure will become readily apparent to those skilled in this art from the following detailed description, wherein only illustrative embodiments of the present disclosure are shown and described. As will be realized, the present disclosure is capable of other and different exemplary implementations, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates a block diagram of an exemplary fuel refilling system, in accordance with some embodiments;

FIGS. 2A, 2B, 2C, 2D, and 2E illustrate an exemplary fuel refilling operation of an open end fuel tank at different stages of refilling, in accordance with some embodiments;

FIG. 2F illustrates an example of a filled closed end fuel tank;

FIG. 3 illustrates an example of a typical direct fill fuel refilling system;

FIG. 4 illustrates an exemplary fuel refilling system, in accordance with some embodiments;

FIG. 5 illustrates an exemplary fuel refilling system, in accordance with some other embodiments;

FIG. 6 illustrates an exemplary fuel refilling system, in accordance with some further embodiments;

FIG. 7 illustrates an example of a typical cascade storage fuel refilling system;

FIG. 8 illustrates an exemplary fuel refilling system, in accordance with some embodiments;

FIG. 9 illustrates an exemplary fuel refilling system, in accordance with some other embodiments;

FIG. 10 illustrates a block diagram of an exemplary fuel refilling system, in accordance with some embodiments;

FIG. 11 illustrates a block diagram of an exemplary fuel refilling system, in accordance with some other embodiments;

FIG. 12 illustrates a block diagram of an exemplary fuel refilling system, in accordance with some other embodiments;

FIG. 13 illustrates a block diagram of an exemplary fuel refilling system, in accordance with some other embodiments;

FIG. 14 illustrates a block diagram of an exemplary fuel refilling system, in accordance with some other embodiments;

FIG. 15 illustrates a block diagram of an exemplary fuel refilling system, in accordance with some other embodiments;

FIG. 16 illustrates a block diagram of an exemplary fuel refilling system, in accordance with some other embodiments;

FIG. 17 illustrates a block diagram of an exemplary fuel refilling system, in accordance with some other embodiments;

FIG. 18 illustrates a plot of the internal fuel tank temperature as a function of pressure, for the fuel refilling system of FIG. 3;

FIG. 19 illustrates plots of the internal fuel tank temperature as a function of pressure for various fuel refilling operations, in accordance with different embodiments;

FIGS. 20 and 21 illustrate plots of the specific refilling wait time as a function of fill quality for the fuel refilling operations depicted in FIG. 19;

FIGS. 22 and 23 illustrate plots of specific energy consumption as a function of fill quality for the fuel refilling operations depicted in FIG. 19; and

FIG. 24 depicts a table summarizing the fill quality (capacity utilization), wait times, and total energy usage for refilling operations using the different cooling circulation loops shown in FIGS. 20, 21, 22, and 23, and for a refilling operation that does not use a cooling circulation loop.

### DETAILED DESCRIPTION

Systems, methods, and apparatuses are provided herein that can reduce temperature and pressure rise associated with heat of compression as a fuel tank is being filled, thereby increasing fuel tank capacity utilization. In some embodiments, the temperature and pressure rise associated with heat of compression can be reduced by at least 10%, 20%, 30%, 40%, 50%, 60%, or more than 60% using one or more of the exemplary fuel refilling systems, compared to using a conventional fuel refilling system. In some embodiments, capacity utilization can be increased up to the maximum allowable (rated) capacity of the fuel tank using one or more of the exemplary fuel refilling systems, compared to using a conventional fuel refilling system. The heat generated from gas compression can be reduced by removing a portion of the heated compressed gas from the fuel tank and replacing it with cooler gas. The removed portion of the heated compressed gas may be recirculated to other components in the system (e.g., a fueling station) and cooled to ambient temperature levels. In some embodiments, a portion of the heated compressed gas may be removed from the fuel tank, passed through a heat exchanger and/or a compressor, and recirculated back to the fuel tank in the form of cooler gas. In other embodiments, a portion of the heated compressed gas may be removed from the fuel tank, introduced into a low pressure gas source pipeline, and recirculated back to the fuel tank after passing through the fuel station. In some further embodiments, a portion of the heated compressed gas may be removed from the fuel tank, stored in one or more storage tanks in a fueling system, and recirculated back to the fuel tank after rejecting heat and returning the gas temperature to ambient levels. The convective mixing of hot gas and cold gas can lower the gas temperature in the fuel tank, which enables a greater amount of gas (i.e., higher density of gas) to be stored in the fuel tank. In particular, the systems, methods, and apparatuses disclosed herein can increase fuel tank capacity utilization compared to existing gas refilling methods. In some embodiments, the systems, methods, and apparatuses disclosed herein can be used in conjunction with existing gas refilling methods (such as over-pressurization) to increase capacity utilization of the fuel tank.

Various aspects of the invention described herein may be applied to any of the particular applications set forth below or for any other types of gaseous fuel monitoring systems. Aspects of the invention may be applied as a standalone system or method, or as part of a vehicle, vehicle fuel tank, or other system that utilizes gaseous fuel or other gases stored under pressure. Such vehicle fuel tanks include those mounted on vehicles, such as cars, wagons, vans, heavy duty vehicles, buses, high-occupancy vehicles, dump trucks, tractor trailer trucks, or other vehicles. The fuel tank may be mounted in many ways including but not limited to side mounting, roof mounting, and rear mounting. For example, the fuel tank may be mounted behind a vehicle cab, on or near a tailgate of the vehicle, on a chassis of the vehicle, in/on a storage container of the vehicle, etc. Any placement of the fuel tank on a vehicle may be contemplated. In some embodiments, the fuel tank may be integrated into the body or chassis of the vehicle. According to embodiments of the invention, these fuel tanks may be filled while mounted on the vehicle or filled before being mounted on the vehicle. It shall be understood that different aspects of the invention can be appreciated individually, collectively, or in combination with each other.

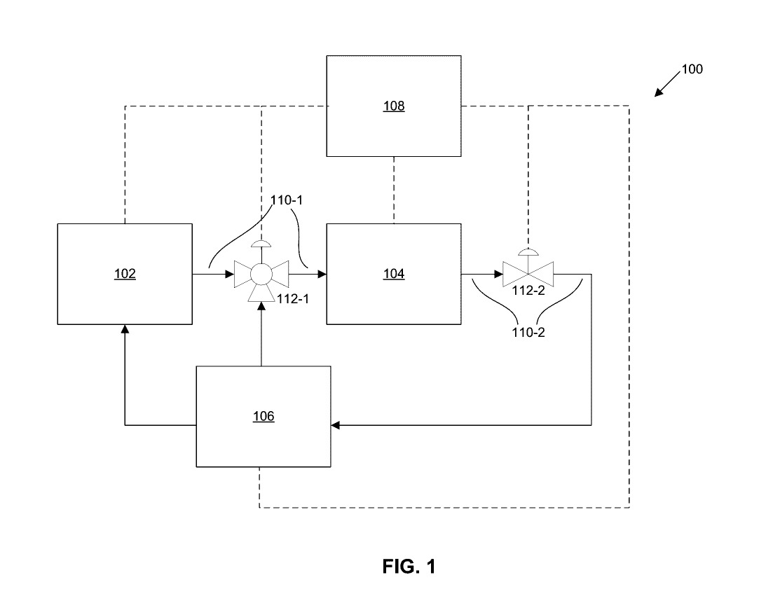

FIG. 1 illustrates a block diagram of an exemplary fuel refilling system, in accordance with some embodiments. The system may be used to refill an empty or a partially filled fuel tank. In addition, the system can be used to fill an empty fuel tank for the first time. The system can be used to fill/refill one or more fuel tanks, either simultaneously, sequentially, or at different time instances.

Referring to FIG. 1, a fuel refilling system 100 may comprise a fueling station 102, a fuel tank 104, a fuel recirculation module 106, a control module 108, a plurality of conduits 110, and a plurality of flow control devices 112. The fuel tank may be connected to the fueling station and the recirculation module via the plurality of conduits, so as to form the closed loop system depicted in FIG. 1.

The fuel tank may be configured to be filled with, and to store a fuel that is provided by the fueling station. The fuel may be a gaseous fuel. The gaseous fuel may be natural gas. For example, the gaseous fuel may be compressed natural gas (CNG). The fuel tank may also be configured to be filled with other gaseous fuels, such as hydrogen or hydrogen-based gases, hythane, HCNG, syngas, nitrogen bottles, helium, argon, carbon dioxide, producer gas, propane, ethane, methane, biogas, and/or other alternative fuels of fuel blends. Where the filled fuel is gaseous, the fuel tank may be capable of storing a fuel having a pressure of less than or equal to about 10000 psi, 8000 psi, 7000 psi, 6000 psi, 5500 psi, 5000 psi, 4750 psi, 4500 psi, 4250 psi, 4000 psi, 3750 psi, 3600 psi, 3500 psi, 3250 psi, 3000 psi, 2750 psi, 2500 psi, 2000 psi, 1500 psi, 1000 psi, 500 psi, 300 psi, 100 psi, or less. In some cases, the fuel tank may be capable of storing a fuel at a pressure greater than about 10000 psi. In some embodiments, the fuel tank may have an operating pressure of about 3600 psig at 70° F. ambient condition and a maximum allowable operating pressure of 4500 psig. The fuel tank may have different operating and maximum allowable pressure limits, depending on the structure and type of material that is used to form the fuel tank, and also the composition of the fuel. The fuel tank may be a structurally rigid tank having a hollow chamber for storing the fuel. The fuel tank may be formed from a rigid material, such as reinforced fiber composite material (e.g., a carbon fiber exterior winding and an aluminum alloy/plastic interior liner). In some embodiments, the fuel tank may be disposed on a vehicle, and may serve as a fuel source to power the vehicle. The fuel tank may be formed in any size and/or shape. For example, in some embodiments, the fuel tank may be a cylinder having hemispherical-shaped end portions. Fuel tanks for storing compressed natural gas may be provided in a plurality of types. The types of tanks may be differentiated based on the materials for fabricating the tank structure, the materials used to line or wrap the inside and outside of the tank, and their manufacturing methods. The type of materials used to fabricate the tank structure typically determines the weight and cost of the tank. Heavier tanks are usually the least expensive and lighter tanks are usually more expensive. The material liner inside and outside of the tank may provide structural reinforcement and protect the tank from gas corrosion. In some cases, the fuel tanks for storing CNG may be classified into Types 1, 2, 3, and 4. Type 1 fuel tanks are typically made of metal (aluminum or steel) and are heavy but low cost. Type 2 fuel tanks typically include a metal liner reinforced by composite wrap (glass or carbon fiber) around the middle (hoop wrapped) and weigh less than Type 1 tanks, but are more expensive. Type 3 fuel tanks typically include a metal liner reinforced by composite wrap around the entire tank, and are lighter than type 1 & 2 but are more expensive. Type 4 fuel tanks typically include a plastic gas-tight liner reinforced by composite wrap around the entire tank, and have the lightest weight but are the most expensive. Although four different types of CNG fuel tanks have been described in the above, it should be noted that the invention can be applied to any existing type of fuel tank, or any type of fuel tank that is developed in the future. Also, the invention need not be limited to a CNG fuel tank, but can also be applied to fuel tanks for storing other types of compressed gas.

In some embodiments, the fuel tank may comprise a hollow interior, a fuel inlet element, and a reinforced insulated wall. The reinforced insulated wall may be built to withstand high pressures when the tank is filled with compressed natural gas. In some cases, the wall insulation may inhibit the dissipation of heat of compression to the outside, which may adversely affect the fuel tank capacity utilization. The fuel tank inlet element may be adapted to be coupled with fuel sources such as fuel filling pumps, particularly CNG filling pumps, found in fuel stations.

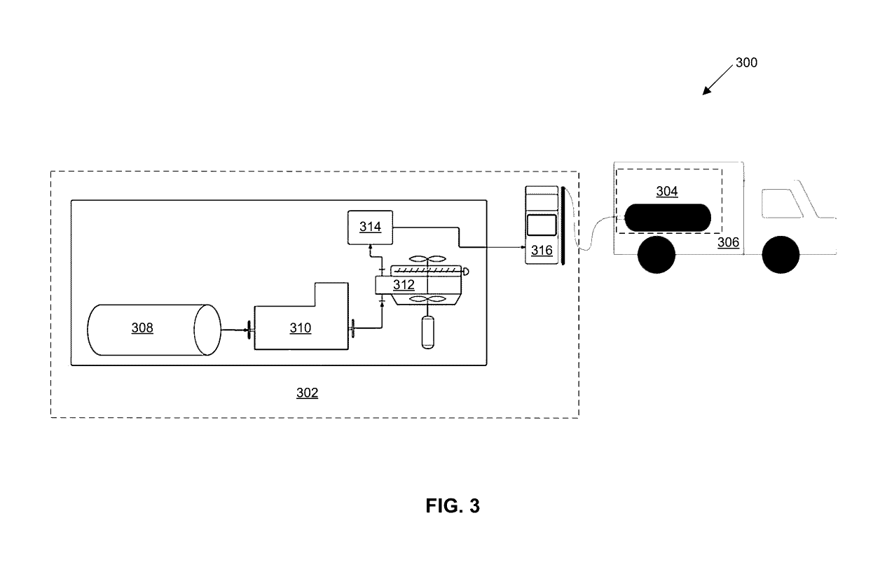

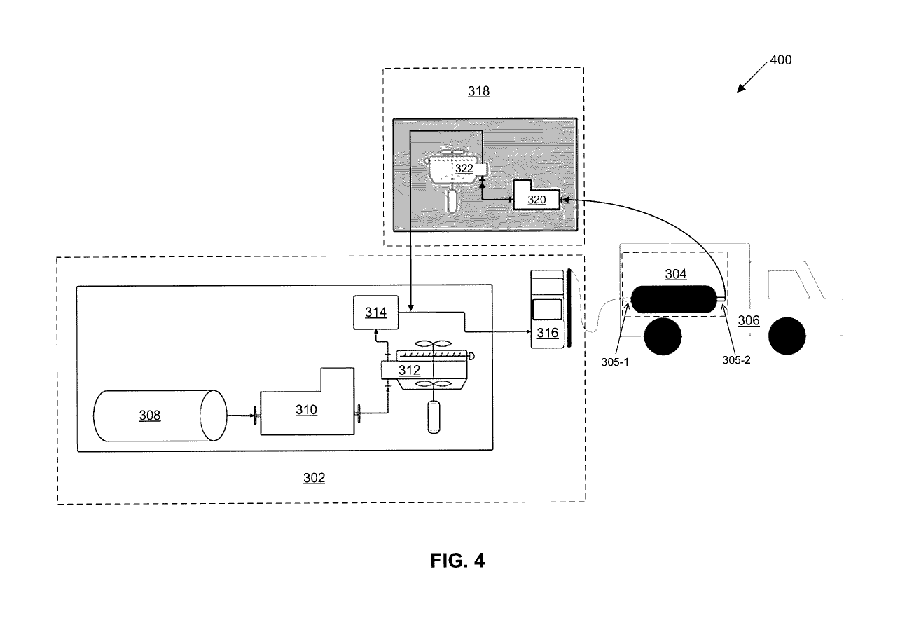

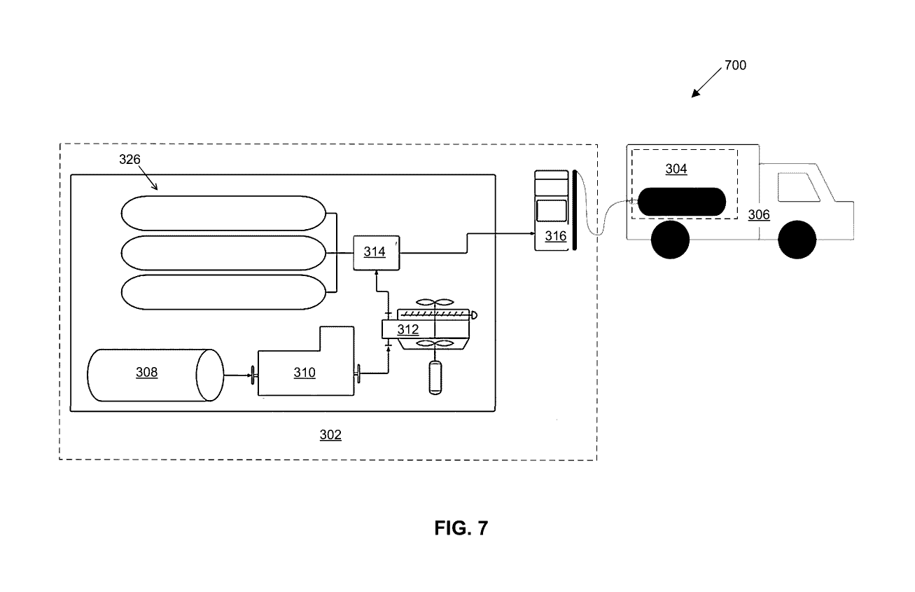

The fueling station may be configured to draw fuel from a fuel source such as a natural gas pipeline. In some embodiments, the fueling station may further include one or more fuel storage banks for storing fuel that is drawn from the fuel source. The fueling station may be configured to provide fuel to the fuel tank, or to a plurality of fuel tanks. In some embodiments, when the fuel is compressed natural gas (CNG), the fueling system may be a direct fill CNG station or a cascade storage CNG station. The components in the direct fill CNG station and the cascade storage CNG station will be described in detail later in the specification with reference to FIGS. 3 and 7.

The fueling station may be placed in selective fluid communication with the fuel tank. This communication may be facilitated using one or more shared pipes, separate pipes, or any combination thereof. The fuel tank can be brought in and out of fluid communication with the fueling station via one or more of the conduits, by using the control module to control the flow of fuel along the conduits via the flow control devices. The conduits may be provided in the form of gas pipes, air ducts, hoses, tubes, etc. The pipes may be formed from a flexible or rigid material. The pipes may be made of an appropriate plastic or metal material that is chemically resistant to the fuel/gas. The pipes may enable a range of flow regimes from laminar to highly turbulent flow of fuel/gas through the pipes.

The fuel may be provided from a fuel dispenser to a receptacle on the vehicle leading into the fuel tank. The fuel dispenser may comprise an electric motor, an engine, a compressor, a blower, meters, pulsers, and/or valves to physically pump and control the fuel flow to the tank. Nozzles may be attached to the compressor or blower via flexible hoses, allowing them to be placed into the vehicle's filling inlet or receptacle. In some cases, a breakaway valve may be fitted to the hose to allow the nozzle and hose to break off and fuel flow to be stopped in case a vehicle drives off with the nozzle still in the filling inlet or when supply pressures reaches unsafe levels.

One or more pipes may define a flow path for the fuel between the fueling station and the fuel tank. For example, as shown in FIG. 1, the plurality of pipes 110 may include an inlet pipe 110-1 and an outlet pipe 110-2. The inlet pipe may be connected between the fueling station and a first opening of the fuel tank. The first opening provides an opening to the hollow chamber/interior of the fuel tank. Fuel may be provided from the fueling station to the fuel tank via the inlet pipe through the first opening.

The outlet pipe may be connected to a second opening of the fuel tank. Likewise, the second opening provides an opening to the hollow chamber/interior of the fuel tank. The outlet pipe may be configured to allow a portion of heated fuel in the fuel tank to flow out of the fuel tank. As previously described, when the fuel tank is filled with a gaseous fuel at high pressure, the temperature of the fuel in the fuel tank may increase due to heat of compression. The increased temperature may lower capacity utilization of the fuel tank, since the capacity utilization is limited by allowable temperature and pressure/structural limits of the fuel tank. In the example of FIG. 1, a portion of the heated fuel can be removed from the fuel tank via the outlet pipe, to be replaced with cooler fuel from the inlet pipe. The convective mixing of hot gas and cold gas can lower the gas temperature in the fuel tank, which can enable a greater amount of gas (i.e., higher density of gas) to be stored in the fuel tank, without compromising the temperature and pressure/structural limits of the fuel tank.

As shown in FIG. 1, each of the fueling station and the fuel tank may be placed in selective fluid communication with the recirculation module. The recirculation module may be connected to the outlet pipe, and may be configured to receive the portion of the fuel that flows out of the fuel tank. In some embodiments, the recirculation module may be a portion of the conduits. In some embodiments, the recirculation module may include a heat exchanger for removing heat from the heated fuel, and a compressor or blower for compressing the fuel. The recirculation module may be configured to direct the compressed/cooled fuel to the fueling station, or to the fuel tank or both via a flow control device (e.g., flow control valve 112-1) in the inlet pipe. In some alternative embodiments, the recirculation module need not include a heat exchanger and a compressor, and may instead direct the heated fuel to the fueling station low pressure line/pipeline for cooling and compression. In those alternative embodiments, the compressed/cooled fuel may be either stored at the fueling station for future use, or dispensed from the fueling station to the fuel tank via the inlet pipe. Accordingly, heated fuel from the fuel tank (which is subsequently compressed and cooled) can be recirculated back to the fuel tank at different junctures of the fuel refilling system, using either the recirculation module alone, or a combination of the recirculation module and the fueling station. In some alternative embodiments, the heated fuel that is removed from the fuel tank may experience a temperature drop and may need to be heated up in order to stay within certain working specifications of a circulation compressor in the recirculation module. In some embodiments, the recirculation module may be configured to circulate the fuel along one conduit (single path), or along a plurality of conduits (multi-path). When the fuel flow is multi-path, the recirculation module may be configured to measure and control the amount of fuel flow along each of the conduits leading into/out of the fuel tank, to reduce temperature and pressure rise associated with heat of compression in the fuel tank. Various recirculation paths of the fuel to/from the fuel tank may be provided in different embodiments of the invention, as described in detail in the specification.

The plurality of flow control devices 112 can be used to control flow of fuel between the fueling station and the fuel tank. The plurality of flow control devices may comprise flow control valves. For example, a flow control valve 112-1 may be disposed along the inlet pipe, and another flow control valve 112-2 may be disposed along the outlet pipe. The valves may be independently controlled, which may allow the fuel tank to independently be brought into or out of fluid communication with one or more pipes. In some instances, each flow control valve may function as a gating mechanism for the flow of fuel gas between the fueling station and the fuel tank. The flow control valve may have an open position that permits fuel gas to flow between the fueling station and the fuel tank. When the flow control valve is in the open position, fluid communication may be provided between the fueling station and the fuel tank. The flow control valve may have a closed position that may prevent fuel gas from flowing between the fueling station and the fuel tank. When the flow control valve is in the closed position, fluid communication is not provided between the fueling station and the fuel tank.

In some instances, a flow control valve may have a binary open and closed position. Alternatively, a flow control valve may be a proportional valve that may control the flow rate of the fuel that flows between the fuel station and the fuel tank. For example, a proportional valve may have a wide open configuration that may permit a greater rate of flow than a partially open configuration that may permit a lesser rate of flow. Optionally, regulating, throttling, metering or needle valves may be used. Return or non-return valves may be used. A valve may have any number of ports. For example, a two-port valve may be used. Alternatively, a three-port, four-port or other type of valve may be used in alternative configurations. Any description herein of valves may apply to any other type of flow control mechanism. The flow control mechanisms may be any type of binary flow control mechanism (e.g., containing only an open and closed position) or variable flow control mechanism (e.g., which may include degrees of open and closed positions).

The control module may be configured to control the flow of fuel between the fueling station and the fuel tank. For instance, the control module may control an on/off state of the flow of fuel along the pipes, by controlling one or more of the flow control valves. The control module may also control and regulate a flow rate and/or a flow pressure of fuel through the pipes or other components within the fuel refilling system. The control module may control a flow rate and/or flow pressure of fuel along a continuous spectrum, or at one or more predefined fuel flow levels. The control module may provide signals that may control flow of fuel at any juncture from the fueling station to the fuel tank. For instance, the control module may control flow from the fueling station to the inlet pipe, along the inlet pipe, along the outlet pipe, between the fuel tank and the recirculation module, between the recirculation module and the fueling station, by using one or more flow control valves, compressors, and/or blowers. Accordingly, the control module may control flow of fuel, which may affect the direction and also the mass flow rate of fuel flow.

The control module may control the flow of fuel in the system, such that a portion of the heated gas in the fuel tank is removed from the fuel tank and replaced with cooler gas from the fueling station. The mixing of cooler gas with the remaining heated gas in the fuel tank can lower the fuel temperature in the fuel tank, which can increase the capacity utilization of the fuel tank. The control module may also control the flow of fuel in the system, such that the fuel tank is filled to a predetermined filling capacity. The predetermined filling capacity may be equal to or greater than 75%, 80%, 85%, 90%, 95%, 99%, or 100% of the rated capacity of the fuel tank. In some embodiments, the predetermined filling capacity may be greater than 100% of the rated capacity of the fuel tank (e.g., in the case of over-pressurization). The control module may further control the flow of fuel in the system, such that the temperature of the fuel in the fuel tank stays within a predetermined temperature limit, and/or the pressure of the fuel in the fuel tank stays within a predetermined pressure limit. Typically, CNG cylinders with a nameplate capacity of 3600 psig may be rated for temperatures ranging from about −40 F to about 180 F. CNG cylinders typically have a maximum allowable pressure rating of 1.25 times the nameplate capacity. For example, CNG cylinders with a nameplate rating of 3600 psig typically have a maximum pressure rating of 4500 psig. Although these standard tank specifications are common within the CNG industry, the filling systems and methods disclosed herein can be adapted to any pressure and temperature nameplate capacity system. The predetermined temperature limit, predetermined pressure limit, and/or predetermined filling capacity may be determined based on the maximum allowable temperature/pressure/structural limits of the fuel tank.

As described above, the control module may control the flow control valves, the flow control valves controlling whether fuel will flow into the fuel tank, as well as the flow rate, pressure, temperature, and amount of fuel flowing into the fuel tank. The control module may generate a signal that may be provided to the flow control valve to indicate whether to open or close the flow control valve, or the degree to which the flow control valve may be opened.

In some embodiments, the control module may be provided at the fueling station. For example, the control module may be implemented as a master controller in the fueling station. In other embodiments, the control module may be provided at the fuel tank or on the vehicle where the fuel tank is mounted. In some alternative embodiments, the control module may be provided remotely from the fueling station and the fuel tank. In those alternative embodiments, the control module may be provided at a remote server, where the control module may be configured to remotely control the fuel refilling operation of the fuel tank. The control module may include one or more processors that may perform one or more steps using non-transitory computer readable media that may define the fuel refilling operation of the fuel tank. The processors may determine, based on data received from a plurality of sensors located in the fuel refilling system, whether to send the signal to the flow control valve, or the type of signal to be sent. The processors may make this determination based on calculations performed on the data or a subset of the data. The control module may have one or more memory units that may include non-transitory computer readable media that may comprise code, logic, or instructions for performing the one or more steps of the fuel refilling operation.

Prior to providing the fuel to the fuel tank, all of the flow control valves may be closed. The fueling station may contain the natural gas therein, which may be prevented from flowing to the fuel tank by the closed flow control valves. A signal may be provided from the control module to each flow control valve that may cause the flow control valve to open. In some instances, signals to open the flow control valves may be provided when the fuel tank is to be filled with fuel (for example, based on a user-generated command, or automatic detection that a fuel tank is empty or near empty). When the flow control valves are opened, fuel may flow from the fueling station to the fuel tank so that the tank can be filled. The fuel may be rapidly provided to the fuel tank. In some instances, the fuel from the fueling station may reach the fuel tank within 1 second, 1.5 seconds, 2 seconds, 3 seconds, 5 seconds, 10 seconds, 15 seconds, 20 seconds, or more than 20 seconds. The amount, flow rate, and/or pressure of the fuel to the fuel tank may be controlled using the control module to control one or more of the flow control valves.

As described above, the control module may receive data from one or more sensors. The sensors may include mass flow sensors, temperature sensors, pressure sensors, mass transducers, pressure indicators (gauges), and/or temperature indicators (gauges) for measuring different characteristics of the fuel flow, at different junctures of the fuel refilling system. For example, the sensors may be placed along a portion of a conduit, in an interior of a conduit, on an exterior of a conduit, in the interior chamber of the fuel tank, on an exterior surface of the fuel tank, at an inlet and/or outlet of a conduit, at a flow control device (e.g., at a valve), at an inlet and/or outlet of the fuel tank, in a fuel storage tank, etc. The placement of the sensors anywhere in the system may be contemplated. Based on the sensor data, the control module may generate, with the aid of one or more processors, a signal that it may send to a flow control valve. In some instances, the signal may cause a flow control valve to open from a closed state. In some embodiments, the signal may dictate the degree to which the flow control valve is opened. In some instances, the signal may cause a flow control valve to close from an open state. In some embodiments, a default setting may be for a flow control valve along the inlet pipe to be open during the fuel refilling operation. Once the flow control valve has opened, it may remain opened as long as the filling continues. In some embodiments, the signal may cause a flow control valve along the outlet pipe to be open during the fuel refilling operation once the temperature of the fuel in the fuel tank exceeds a predetermined threshold temperature, when the pressure of the fuel in the fuel tank exceeds a predetermined threshold pressure, and/or when the fuel tank reaches a predetermined filling capacity. In some embodiments, different signals may be sent to different flow control valves. For example, during the fuel refilling operation, a first signal may cause the flow control valve along the inlet pipe to be open to a greater degree (i.e., allowing a greater amount of fuel to flow into the fuel tank), and a second signal may cause the flow control valve along the outlet pipe to be open to a lesser degree (i.e., allowing a smaller amount fuel to flow out of the fuel tank), such that the fuel tank can be filled within a predetermined time period, while controlling/reducing temperature rise due to heat of compression in the fuel tank during the refilling operation. The flow control valves may be closed when the fuel tank is filled, or in the event of a detected malfunction or other type of specified event. The detected malfunction may include gas leak, fuel tank overheating, and other abnormal events associated with operation of the fuel refilling system.

Fuel may be supplied to the fuel tank via the pipes until a pressure of the fuel in the fuel tank reaches a predetermined threshold pressure and/or a predetermined threshold temperature. The control module may be configured to monitor the pressure and temperature of the fuel in the fuel tank, and to shut off the supply of fuel to the fuel tank via one or more of the flow control valves when the pressure/temperature of the fuel in the fuel tank reaches the predetermined threshold pressure and/or temperature. The pressure of the fuel may be monitored using one or more gas pressure sensors located in the fuel tank or along the pipes. For instance, a gas pressure sensor may be located along the pipes after each control valve. The gas pressure sensors may be configured to provide pressure feedback signals to the control module. One or more gas pressure sensors may also be disposed within the chamber of the fuel tank. The temperature of the fuel in the fuel tank may be monitored using temperature sensors located on the inner walls of the fuel tank, and/or one or more temperature sensing probes extending into the chamber of the fuel tank. For CNG systems, the predetermined threshold pressure may be about 3600 psig. When utilizing over-pressurization to further increase cylinder capacity utilization, the final pressure may be elevated above the temperature compensated pressure for the given ambient conditions, while accounting for settling and respecting the structural and thermal limitations of the fueling tank. In some embodiments, the predetermined pressure may be less than 3600 psig. For example, some CNG systems may be rated to 3000 psig. In some other embodiments, the predetermined threshold pressure may be greater than 3600 psig. For example, hydrogen gas systems may have ratings up to 10,000 psig or greater than 10,000 psig. The fueling systems and method described herein can be adapted to virtually any filling system with any filling pressure and/or temperature range.

Optionally, the predetermined threshold pressure may be individualized to different types of fuel tanks. For instance, as a pressure within a fuel tank reaches a particular predetermined threshold pressure value, the gas flow may automatically shut off to that fuel tank. Different fuel tanks may reach a predetermined threshold pressure at the same time or at different times. The predetermined threshold pressure for each fuel tank may be the same, or may be different.

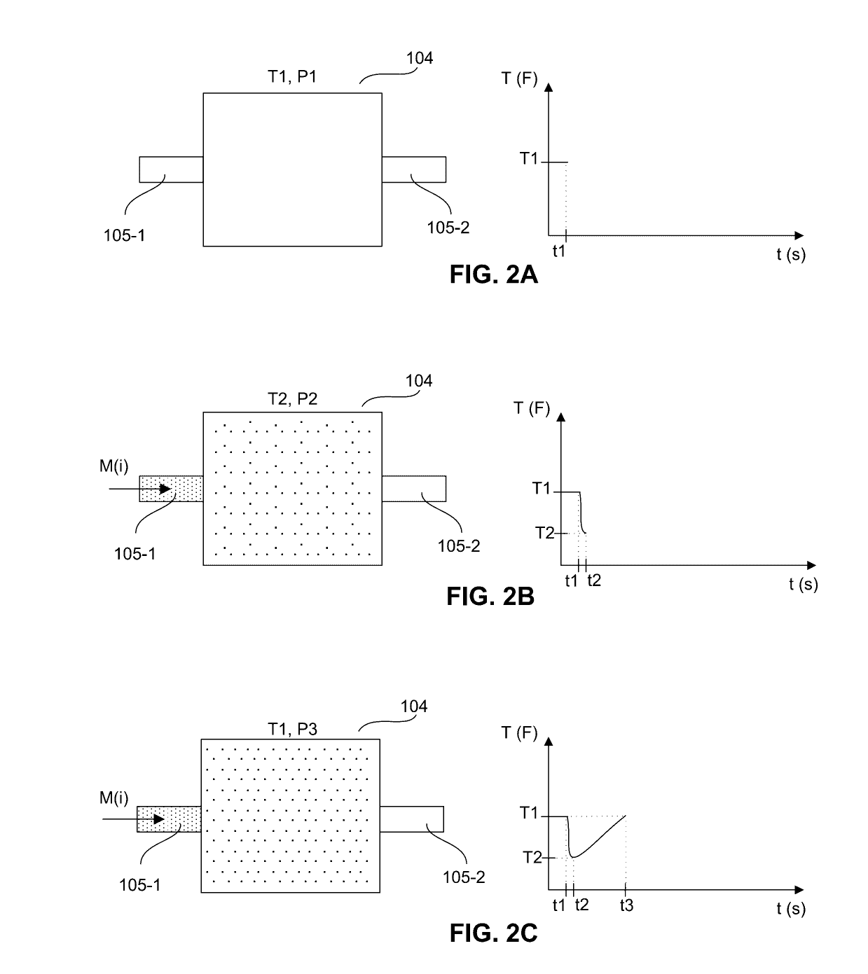

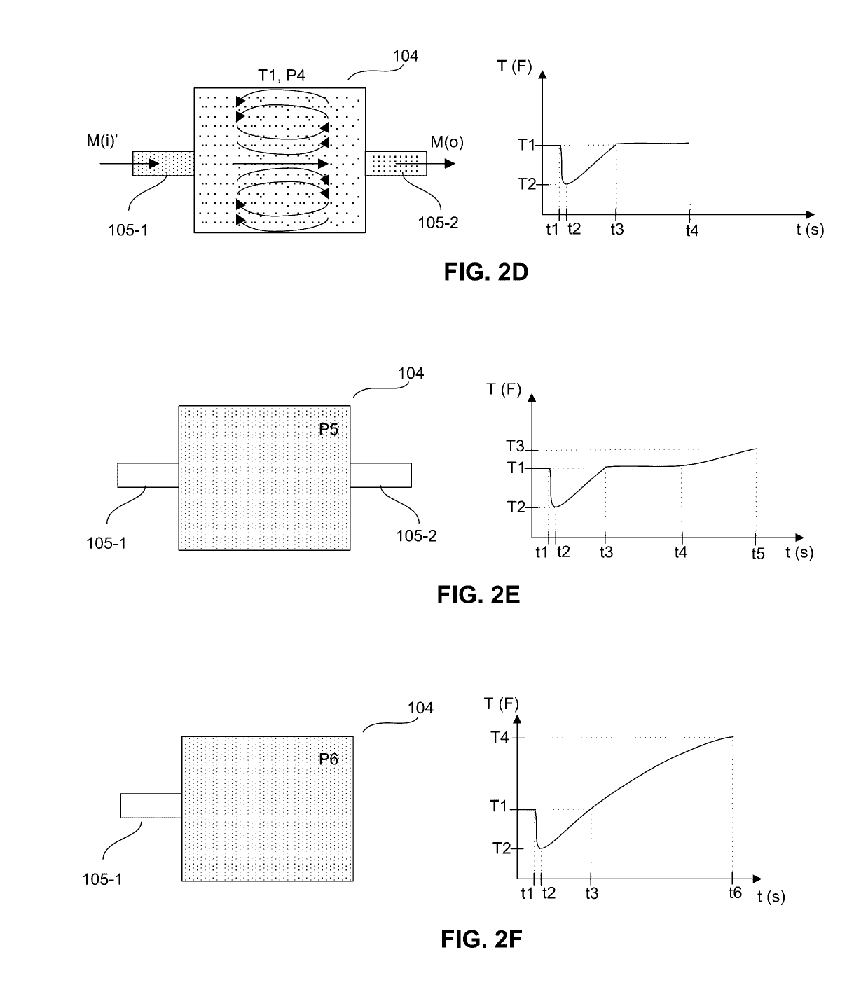

FIGS. 2A, 2B, 2C, 2D, and 2E illustrate an exemplary fuel refilling operation of a fuel tank, in accordance with some embodiments.

Referring to FIG. 2A, a fuel tank 104 may include an inlet pipe 105-1 and an outlet pipe 105-2, and may be initially empty or nearly empty. The interior of the fuel tank may have a temperature T1 and a pressure P1. In some embodiments, the temperature T1 may be substantially the same as the temperature of the ambient environment in which the fuel tank is located. In some embodiments, the fuel tank may be purged with an inert gas prior to filling (to reduce flammability risks), and drained to a low pressure (e.g., about 25 psig). In those embodiments, the pressure P1 may correspond to the pressure within the purged fuel tank (e.g., about 25 psig).

Referring to FIG. 2B, the control module may generate a signal to open one or more flow control valves between the fueling station and the fuel tank at time t1, so as fill the fuel tank with fuel from the fueling station. The fuel may flow into the fuel tank through the inlet pipe at a mass flow rate M(i). The compressed fuel from the fueling station is typically dispensed into the fuel tank at high pressure. When the compressed fuel passes through the inlet pipe into the fuel tank, the fuel undergoes rapid expansion in the fuel tank which has a larger volume of space. The free rapid expansion of the fuel causes its temperature to drop due to the Joule-Thomson effect. As shown in FIG. 2B, the temperature of the fuel in the fuel tank decreases from temperature T1 at time t1 to temperature T2 at time t2, where T2<T1. The partially filled fuel tank also has a pressure P2 that is greater than the pressure P1. It should be noted that when the temperature T1 is at ambient temperature, all gases except hydrogen, helium, and neon cool upon expansion by the Joule-Thomson process. Hydrogen, helium, and neon will experience the same effect but only at lower temperatures.

Referring to FIG. 2C, as the fuel tank is being filled with more fuel, the density of the fuel in the fuel tank becomes higher (i.e., the fuel becomes more compressed), and there is less free expansion of the fuel gas molecules since the gas molecules are now closer together. As shown in FIG. 2C, the temperature of the fuel in the fuel tank starts to rise beginning from time t2 due to heat of compression, and reaches the original ambient temperature T1 at time t3. At time t3, the partially filled fuel tank may have a pressure P3 that is greater than the pressure P2.

Referring to FIG. 2D, when the temperature of the fuel reaches or exceeds the temperature T1, the control module may generate a signal to open a flow control valve along the outlet pipe, so as to allow a portion of the heated fuel to be removed from the fuel tank. In some other embodiments, the signal may be generated when the temperature of the fuel exceeds a predetermined threshold temperature T′. The predetermined threshold temperature T′ may be lower than the temperature T1. Alternatively, the predetermined threshold temperature T′ may be higher than the temperature T1. Additionally, in some embodiments, the predetermined threshold temperature T′ may lie between the temperature T1 and another final temperature T3, where T3>T1. In some further embodiments, the predetermined threshold temperature T′ may correspond to the lowest Joule-Thomson temperature achieved within the fuel tank.

In the example of FIG. 2D, the signal from the control module may cause the portion of the heated fuel to flow out of the fuel tank through the outlet pipe at a mass flow rate M(o). In some embodiments, M(o) may be less than M(i). In other embodiments, M(o) may be greater than M(i). In some further embodiments, M(o) may be substantially equal to M(i). When the heated fuel is flowing out from the fuel tank through the outlet pipe, cooler ambient temperature fuel continues to flow into the fuel tank through the inlet pipe at the mass flow rate M(i). The outgoing mass flow rate M(o) may be less than the incoming mass flow rate M(i), so that the net mass flux to the fuel tank is positive and the fuel tank can be filled to a predetermined filling capacity. In some embodiments, the control module may increase the mass flow rate M(i) to a higher mass flow rate M(i)′, to compensate for the removal of the heated fuel from the fuel tank. The convective mixing of the ambient temperature supply fuel with the remaining heated fuel in the fuel tank prevents the fuel temperature in the tank from rapidly increasing due to heat of compression. The convective mixing may include natural mixing of the heated/cool gas or forced mixing of the heated/cool gas. In particular, the forced mixing of the heated/cool gas (coupled with substantially high incoming/outgoing mass flow rates) can generate swirling and turbulence of the gas within the tank. The increased turbulence can remove localized hot/cold spots within the tank, and allow gas temperatures to be distributed evenly within the tank. As shown in FIG. 2D, the temperature of the fuel in the fuel tank does not rise substantially above the temperature T1 due to the influx of ambient temperature or relatively cooled fuel. At time t4, the partially filled fuel tank may have a pressure P4 that is greater than the pressure P3, but at substantially the same temperature as time t3.

Referring to FIG. 2E, when the fuel tank reaches a predetermined filling capacity (i.e., achieved a certain capacity utilization), the control module may generate signals to shut off the flow control valves along the inlet pipe and the outlet pipe. The predetermined filling capacity may be based on a temperature and/or pressure of the fuel in the fuel tank. The predetermined filling capacity may also be indicated to the station through advanced vehicle-station communication systems. The predetermined filling capacity may be indicative of the percentage that the fuel tank has been filled (i.e., capacity utilization). As shown in FIG. 2E, when the fuel refilling operation is completed at time t5, the temperature of the fuel in the fuel tank may be at temperature T3, which may have a low temperature delta to the ambient temperature T1. The final gas pressure of the filled fuel tank may be given by P5. The final pressure P5 may depend on the ambient temperature at which the process is carried out and in some instances, the degree of temperature-compensated over-pressurization required to reach complete filling. In some embodiments, the pressure P5 may range from about 3600 psig to about 4500 psig. In some other embodiments, the pressure P5 may be greater than 4500 psig, such as with hydrogen systems that can reach pressures of or greater than 10,000 psig. When the gas temperature settles from temperature T3 to T1, the pressure will drop accordingly provided that density remains the same and no other changes to the system (fuel tank) occurs. At any constant density, the temperature and pressure of the gas will vary proportionally. For natural gas, as temperature decreases, pressure will reduce. Other gases may behave differently or reach condensation points depending on the state in question. In FIG. 2E, due to the low temperature delta, the pressure drop may not be as significant compared to conventional refilling systems. As a result, the system of FIG. 2E can achieve a higher fuel tank capacity utilization compared to conventional refilling systems.

As previously noted, hydrogen, helium and neon do not cool upon expansion by the Joule-Thomson process when the temperature T1 is at ambient temperature. Instead, those gases experience a rise in temperature almost immediately due to heat of compression, when they are dispensed into the fuel tank at high pressures. Since there is no Joule-Thomson effect for those gases, the control module may generate signals to induce forced mixing of heated/cool gas (coupled with substantially high incoming/outgoing mass flow rates) at the start of the filling process, or once the gas temperature exceeds the temperature T1.

FIG. 2F illustrates an example of a fuel tank having an inlet pipe, but without an outlet pipe. The example of FIG. 2F is a closed end (one-port) fuel refilling system. In other words, fuel can only enter the fuel tank but cannot exit the fuel tank. The closed end (one-port) fuel refilling system may be an open loop system. In contrast, the embodiment of FIGS. 2A through 2E is an open end (two-port) fuel refilling system, in which fuel can enter and exit the fuel tank at the same time or at different times. The open end (two-port) fuel refilling system may be a closed loop system.

In the example of FIG. 2F, there is no heat removal mechanism to reduce the effects of heat of compression in the fuel tank as it is being filled. Unlike the embodiment of FIGS. 2A through 2E, the fuel tank of FIG. 2F does not have an outlet pipe through which a portion of the heated fuel can be removed, to be replaced with cooler ambient temperature fuel from the inlet pipe. As a result, the fuel cannot be removed from the system, and can only flow in one direction—i.e., from the fueling station to the fuel tank. The fuel temperature in the tank will rise due to heat of compression, which may ultimately lead to an under-filled condition, particularly when ambient temperatures are high. The final pressure of the fuel tank in FIG. 2F may be P6, whereby P6 is less than P5 due to the under-filled condition.

As shown in FIG. 2F, due to the lack of a heat removal mechanism, the fuel temperature in the tank may increase beyond temperature T3, and continue to rise to temperature T4 at time t6. The temperature T4 may be substantially higher than the temperature T3. However, since the walls of some fuel tanks are thermally insulated, it may take a substantial amount of time for the temperature T4 of the fuel to drop to the ambient temperature T1. In the example of FIG. 2F, the temperature rise due to heat of compression is substantially retained in the fuel tank since the heat is not removed during the refilling operation. In contrast, in FIGS. 2A through 2E, the temperature and pressure rise associated with heat of compression can be reduced by removing a portion of the heated fuel and replacing it with cooler ambient temperature fuel during the refilling operation. As a result, the embodiment of FIGS. 2A through 2E has improved (increased) capacity utilization compared to the example of FIG. 2F. Upon completion of the refilling operation, the fuel tank in FIG. 2E can reach the ambient temperature T1 much faster than the fuel tank in FIG. 2F, since the fuel tank in FIG. 2E has a lower temperature delta compared to the fuel tank in FIG. 2F.

FIG. 3 illustrates an example of a type of fuel refilling system. Referring to FIG. 3, a fuel refilling system 300 may comprise a fueling station 302 and a fuel tank 304. The fuel tank may be configured to be filled with, and to store CNG. The fuel tank may be located on a vehicle 306. In the example of FIG. 3, the fueling station may be a direct fill CNG station. The direct fill CNG station may be configured to: (1) draw natural gas from a low pressure natural gas pipeline 308 and/or other sources; (2) compress the gas using a compressor 310 (e.g., a reciprocating compressor); (3) remove heat from the compressed gas using a heat exchanger 312 (e.g., an air-cooled exchanger); and (4) dispense the compressed gas at an approximately ambient temperature to the fuel tank through a gas dispenser. The direct fill CNG station may further include a priority panel 314 configured to control gas flow to one or more gas dispensers 316 for dispensing gas to the fuel tank. The direct fill CNG station is typically used in high vehicle throughput stations.

The fuel refilling system in FIG. 3 is a closed end (one-port) system. In other words, gas can only enter the fuel tank but cannot exit the fuel tank during filling operations. As a result, the gas cannot be removed from the system, and can only flow in one direction—i.e., from the fueling station to the fuel tank. The fuel temperature in the tank will rise due to heat of compression, which may ultimately lead to an under-filled condition.

In contrast to FIG. 3, the embodiments of FIGS. 4, 5, and 6 can be used to reduce the temperature and pressure rise from heat of compression and to improve the capacity utilization of the fuel tank, as described below.

FIG. 4 illustrates an exemplary fuel refilling system, in accordance with some embodiments. Referring to FIG. 4, an exemplary fuel refilling system 400 may comprise a fueling station 302, a fuel tank 304, and a fuel recirculation module 318. The fuel tank may be configured to be filled with, and to store CNG. The fuel tank may be located on a vehicle 408. The fueling station may comprise a direct fill CNG station.

Unlike the example of FIG. 3, the fuel refilling system of FIG. 4 is an open end (two-port) system, in which fuel can enter and exit the fuel tank at the same time or at different times. As shown in FIG. 4, the fuel tank can be filled with compressed gas from the dispenser of the fueling station via a first opening 305-1 in the fuel tank. A portion of the heated gas may be removed from the fuel tank via a second opening 305-2 in the fuel tank, and directed to the recirculation module. A compressor 320 (e.g., a reciprocating compressor) in the recirculation module may be configured to drive the mass flow rate for the recirculation heat removal process. The temperature of the gas may rise due to heat of recompression at the compressor. The compressed gas may be subsequently passed through a heat exchanger 322 (e.g., an air-cooled exchanger) in the recirculation module to remove heat from the compressed gas, before the compressed gas is recirculated back to the fueling station and/or the fuel tank. The heat exchanger can also remove the temperature and pressure rise from heat of compression generated earlier from the fueling process within the fuel tank. The compressed and cooled gas may be directed into a pipe located between the priority panel and the dispenser, and subsequently dispensed back to the fuel tank. As previously described, the convective mixing of the cooler intake gas with the remaining heated gas in the fuel tank can reduce the gas temperature in the fuel tank, which can lead to improved fuel tank capacity utilization.

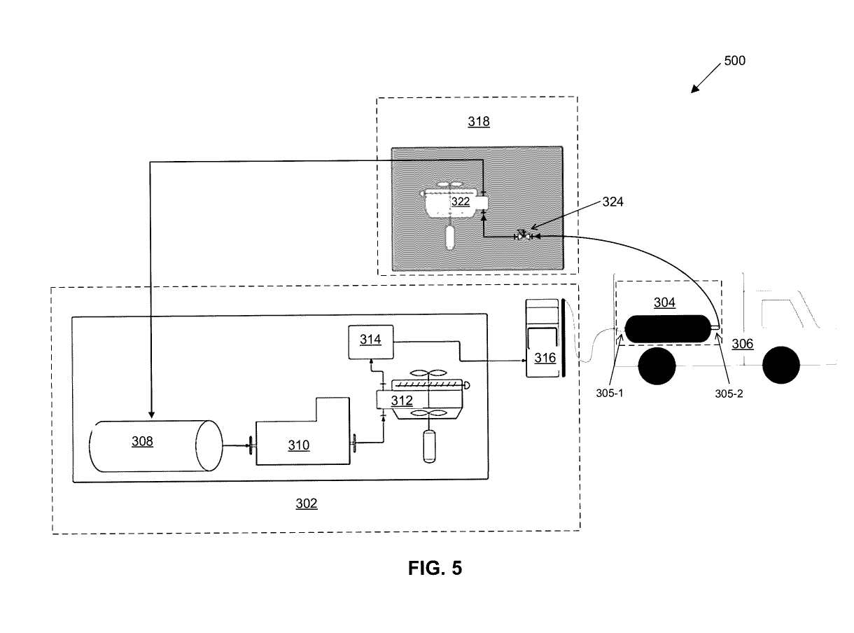

FIG. 5 illustrates an exemplary fuel refilling system 500, in accordance with some other embodiments. The embodiment of FIG. 5 is similar to the embodiment of FIG. 4 in that a portion of the heated gas is removed from the fuel tank, and passes through a heat exchanger (e.g., an air-cooled exchanger) in the recirculation module to remove heat from the gas. The removed portion of the heated gas in the fuel tank may be replaced with relatively cooler gas from the inlet pipe. As previously mentioned, the mixing of the cooler intake gas with the remaining heated gas in the fuel tank can reduce the gas temperature in the fuel tank, which can lead to improved fuel tank capacity utilization.

However, the embodiment of FIG. 5 may be different from the embodiment of FIG. 4 in the following aspects. In FIG. 5, the gas that is removed from the fuel tank may be directed further upstream in the fueling station. For example, as shown in FIG. 5, the recirculation module may direct the gas to the low pressure CNG pipeline in the fueling station, instead of the pipe located between the priority panel and the dispenser. Since the gas is directed to the low pressure CNG pipeline, there is no need to compress the gas at the recirculation module 318. Accordingly, a compressor may be omitted from the recirculation module, and replaced by a gas regulator 324. The gas regulator may be configured to regulate the pressure and flow of gas from the outlet pipe into the heat exchanger of the recirculation module. The cooled gas is then reintroduced from the heat exchanger of the recirculation module back to the low pressure CNG pipeline. The heat exchanger may add heat to the expanded gas, in order to keep pipeline gas temperature and/or supply temperature to the station compressor above acceptable temperature limits. Mass flow out of the fuel tank may be driven by differential pressure, and therefore may require specialized valve, orifice, and/or piping sizing to accomplish the mass removal necessary for the process. Since the gas compression is performed using only one compressor (the reciprocating compressor in the fuel station), the size/power of the reciprocating compressor may need to be scaled up to accommodate the increased mass flow of the gas, in order to maintain gas filling wait times.

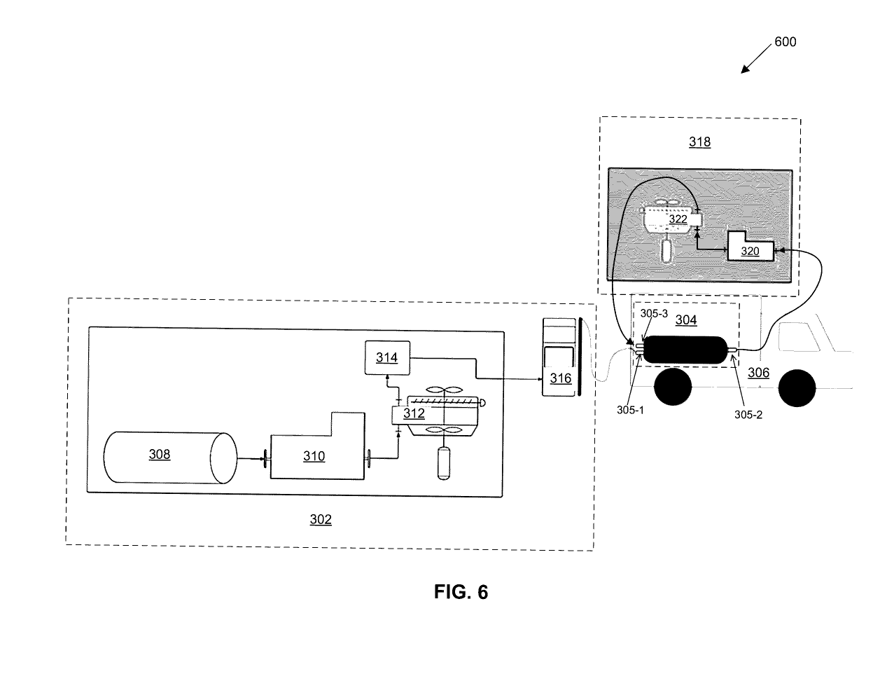

FIG. 6 illustrates an exemplary fuel refilling system 600, in accordance with some further embodiments. The embodiment of FIG. 6 is similar to the embodiment of FIG. 4 in that a portion of the heated gas is removed from the fuel tank and directed to the recirculation module. The gas may be compressed using a compressor (e.g., a reciprocating compressor) in the recirculation module, and passed through a heat exchanger (e.g., an air-cooled exchanger) in the recirculation module to remove heat from the compressed gas. The compressor is used to generate the flow rate required for the process to successfully reduce or control the gas temperature within the fuel tank. The removed portion of the heated gas in the fuel tank may be replaced with cooler gas from the inlet pipe. As previously mentioned, the mixing of the cooler intake gas with the remaining heated gas in the fuel tank can reduce the gas temperature in the fuel tank, which can lead to improved fuel tank capacity utilization.

However, the embodiment of FIG. 6 may be different from the embodiment of FIG. 4 in the following aspects. In FIG. 6, the gas that is removed from the fuel tank is not directed from the recirculation module back to the fueling station. Instead, the compressed and cooled gas is directed back to the fuel tank from the recirculation module. In some embodiments, the fuel tank 604 in FIG. 6 may include a third opening 305-3 for receiving the compressed and cooled gas from the recirculation module. In those embodiments, the fuel refilling system of FIG. 6 may be an open end (three-port) system, in which fuel can simultaneously enter the fuel tank via the first opening and the third opening (i.e., two ports), and exit the fuel tank via the second opening (i.e., one port). In some embodiments, the fuel supply and circulation fuel may converge in a manifold to reduce the number of ports physically located on the fuel tank.

FIG. 7 illustrates an example of another type of fuel refilling system. Referring to FIG. 7, a fuel refilling system 700 may comprise a fueling station 302 and a fuel tank 304. The fuel tank may be configured to be filled with, and to store CNG. The fuel tank may be located on a vehicle. The fueling station may comprise a cascade storage CNG system 326. The cascade storage CNG system may be a high pressure gas cylinder system that is used for the refilling of smaller compressed gas cylinders or air cylinders. The smaller compressed gas cylinders or air cylinders may include, for example, fuel tanks. Each of the large cylinders may be filled by a compressor, and the cascade system can allow small cylinders (e.g., fuel tanks) to be filled from storage rather than directly from a compressor. In addition, a cascade system may be used as a reservoir to allow a low-capacity compressor to meet the demand of filling several small cylinders (e.g., fuel tanks) in succession.

The cascade storage CNG station in FIG. 7 may be similar to the direct fill CNG station in FIG. 3 except for the following differences. In the cascade storage CNG station, the compressed and cooled gas may be stored in a cascade storage bank prior to being dispensed to the fuel tank. The cascade storage bank may include a plurality of storage tanks that are configured to store compressed gas at different pressures. Any number and/or type of storage tank in the cascade storage bank may be contemplated. For example, in some embodiments, the cascade storage bank may comprise a low pressure storage tank for storing gas at a pressure of approximately 1500 psig, a medium pressure storage tank for storing gas at a pressure of approximately 3000 psig, and a high pressure storage tank for storing gas at a pressure of approximately 4500 psig. In some alternative embodiments, the plurality of storage banks in the cascade storage bank may be configured to store compressed gas at substantially a same pressure. For example, the plurality of storage banks may store gas at a pressure of approximately 3600 psig, 3700 psig, 3800 psig, 3900 psig, 4000 psig, or more than 4000 psig. In some cases, the plurality of storage banks may store gas at a pressure of approximately 3500 psig, 3400 psig, 3300 psig, 3200 psig, 3100 psig, 3000 psig, or less than 3000 psig. The cascade storage CNG station may further include a priority panel configured to control gas flow from the cascade storage bank to one or more gas dispensers for dispensing gas to the fuel tank.

The fuel refilling system of FIG. 7 is a closed end (one-port) system. In other words, gas can only enter the fuel tank but cannot exit the fuel tank. As a result, the gas cannot be removed from the vehicle fuel system by the station, and can only flow in one direction—i.e., from the fueling station to the fuel tank. The fuel temperature in the tank will rise due to heat of compression, which may ultimately lead to an under-filled condition.

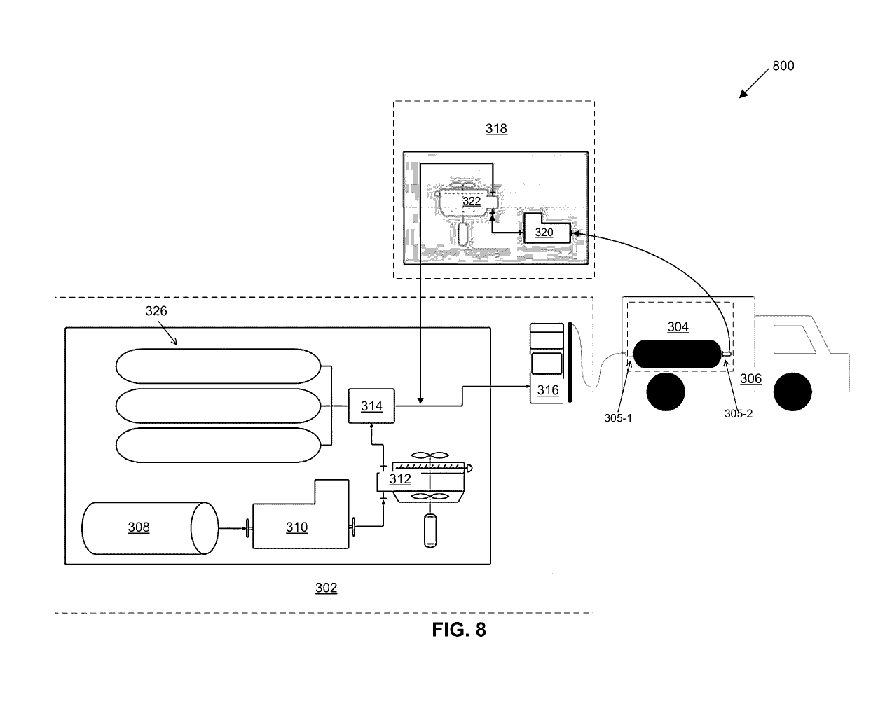

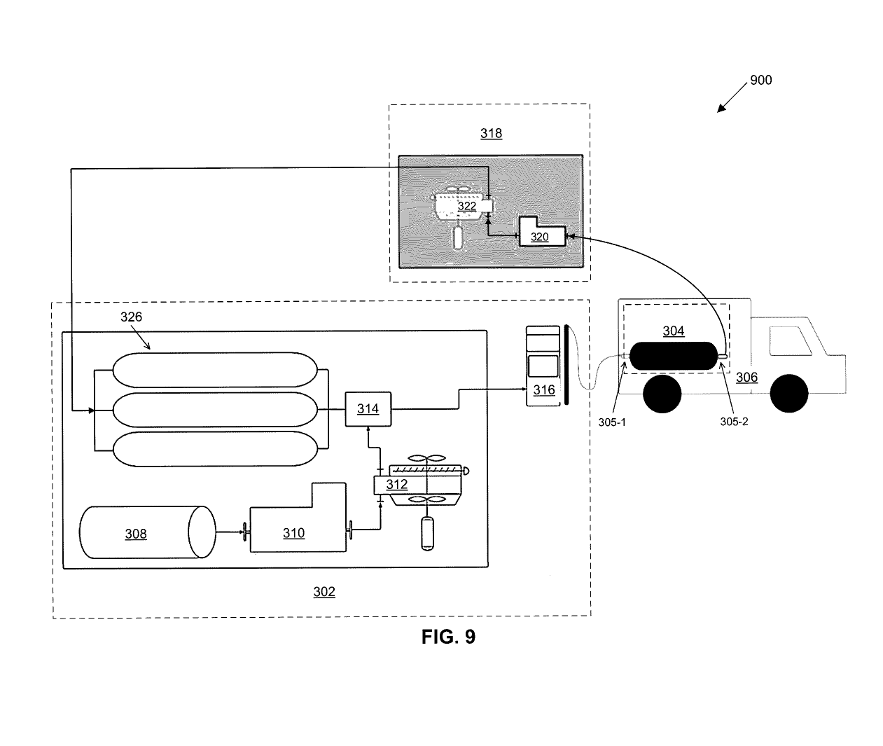

In contrast to FIG. 7, the embodiments of FIGS. 8 and 9 can be used to reduce the temperature and pressure rise associated with heat of compression and to improve the capacity utilization of the fuel tank, as described below. Additionally, any of the embodiments that apply to direct fill stations, can also be adapted to the cascade fill station.

FIG. 8 illustrates an exemplary fuel refilling system, in accordance with some embodiments. Referring to FIG. 8, an exemplary fuel refilling system 800 may comprise a fueling station 302, a fuel tank 304, and a fuel recirculation module 318. The fuel tank may be configured to be filled with, and to store CNG. The fuel tank may be located on a vehicle. The fueling station may comprise a cascade storage CNG station.

Unlike the example of FIG. 7, the fuel refilling system of FIG. 8 is an open end (two-port) system, in which fuel can enter and exit the fuel tank at the same time or at different times. As shown in FIG. 8, the fuel tank can be filled with compressed gas from the dispenser of the fueling station via a first opening 305-1 in the fuel tank. A portion of the heated gas may be removed from the fuel tank via a second opening 305-2 in the fuel tank, and directed to the recirculation module. Since the removed gas loses pressure when it exits from the fuel tank and travels along the outlet pipe, the gas may be directed to a compressor 320 (e.g., a reciprocating compressor) in the recirculation module to recompress the gas. However, the heat of compression may cause the temperature of the gas to rise. Accordingly, the compressed gas may be passed through a heat exchanger 322 (e.g., an air-cooled exchanger) in the recirculation module to remove heat from the compressed gas, before the compressed gas is re-introduced back to the fueling station and/or the fuel tank. The compressed and cooled gas may be directed into a pipe located between the priority panel and the dispenser, and recirculated back to the fuel tank. As previously described, the mixing of the cooler intake gas with the remaining heated gas in the fuel tank can reduce the gas temperature in the fuel tank, which can lead to improved fuel tank capacity utilization.

FIG. 9 illustrates an exemplary fuel refilling system, in accordance with some other embodiments. The embodiment of FIG. 9 may be similar to the embodiment of FIG. 8 in that a portion of the heated gas is removed from the fuel tank, and passes through a heat exchanger (e.g., an air-cooled exchanger) in the recirculation module to remove heat from the gas. The removed portion of the heated gas in the fuel tank may be replaced with cooler gas from the inlet pipe. As previously mentioned, the mixing of the cooler intake gas with the remaining heated gas in the fuel tank can reduce the gas temperature in the fuel tank, which can lead to improved fuel tank capacity utilization.

However, the embodiment of FIG. 9 may be different from the embodiment of FIG. 8 in the following aspects. In FIG. 9, the gas that is removed from the fuel tank may be directed further upstream in the fueling station. For example, as shown in FIG. 9, the recirculation module 318 may direct the gas to the cascade storage bank 326 in the fueling station, instead of the pipe located between the priority panel and the dispenser. The compressed and cooled gas from the recirculation module may be stored in one or more storage tanks in the cascade storage bank. The gas from the recirculation module may be used to replenish the one or more storage tanks. In some embodiments, a first portion of the gas from the recirculation module may be stored in the low pressure storage tank; a second portion of the gas from the recirculation module may be stored in the medium pressure storage tank; and a third portion of the gas from the recirculation module may be stored in the high pressure storage tank. In some embodiments, the first portion, second portion, and third portion of the gas may be substantially the same. In other embodiments, the first portion, second portion, and third portion of the gas may be substantially different. Any mass ratio of the first portion, second portion, and third portion of the gas from the recirculation module may be contemplated. The recirculation module may be further configured to prioritize/choose the sequence or order in which gas is directed to and stored in the storage tanks. For example, in some embodiments, the gas may be stored in the high pressure storage tank first, followed by the medium pressure storage tank, and finally the low pressure storage tank. Conversely, in other embodiments, the gas may be stored in the low pressure storage tank first, followed by the medium pressure storage tank, and finally the high pressure storage tank. The portions of the gas stored in each of the tanks may be the same or different, as previously described. Any order or priority of gas storage in the cascade storage bank may be contemplated.

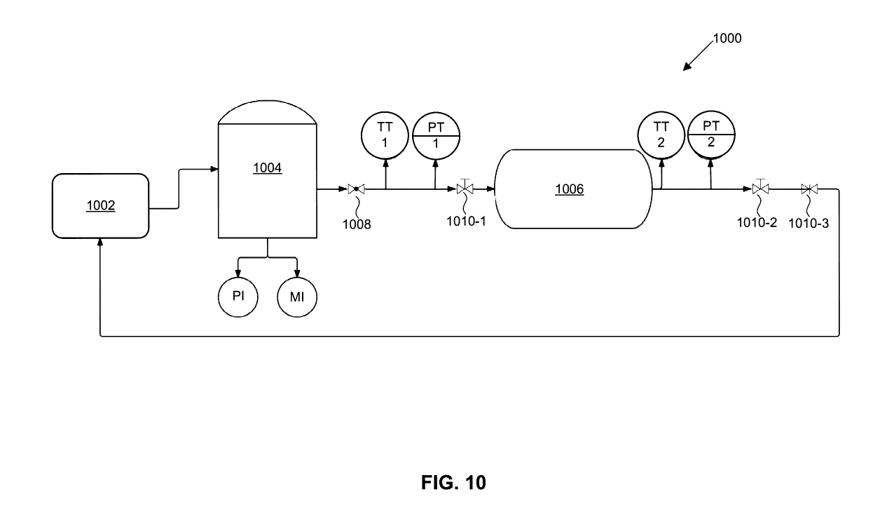

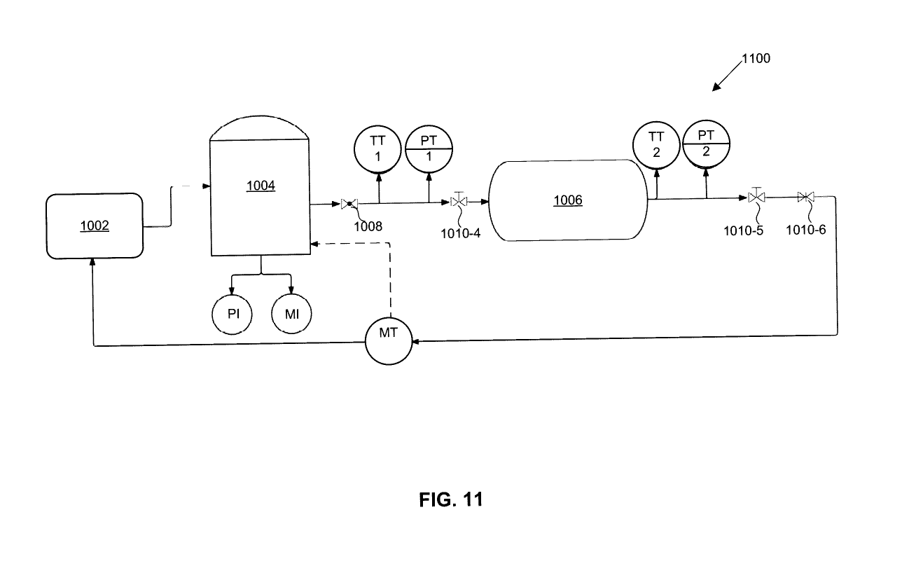

FIGS. 10 and 11 illustrate block diagrams of an exemplary fuel refilling system, in accordance with some embodiments. Referring to FIGS. 10 and 11, a fuel refilling system 1000/1100 may include a natural gas pipeline 1002, a fuel station 1004, a fuel tank 1006, a plurality of pipes, a fill receptacle 1008, a plurality of valves 1010, and a plurality of sensors. The plurality of valves may include gate valves 1010-1 and 1010-2, a needle valve 1010-3, a cylinder valve 1010-4, a cylinder secondary valve 1010-5, a fill bleed valve 1010-6, and/or any other type of valves. The plurality of sensors may include temperature transducers (TT1 and TT2), pressure transducers (PT1 and PT2), a mass indicator (MI), a pressure indicator (PI), a mass transducer (MT), and/or any other type of sensors. The natural gas pipeline, fuel station, and the fuel tank may be in selective fluid communication via the plurality of pipes connected thereto.

The natural gas pipeline may be configured to transport natural gas at a low pressure (e.g., about 200 psig). The fuel station may be configured to draw natural gas from the gas pipeline, compress the gas, and cool the gas, before dispensing it to the fuel tank. In some embodiments, the fuel station may include a compressor (e.g., a reciprocating compressor) to compress the gas, and a heat exchanger (e.g., an air-cooled exchanger) to cool the compressed gas. In some embodiments, the gas may be compressed at the fuel station to a pressure of about 3600 psig. In some other embodiments, the gas may be compressed at the fuel station to a pressure of less than 3600 psig, 3500 psig, 3400 psig, 3300 psig, 3200 psig, 3100 psig, or 3000 psig. In some further embodiments, the gas may be compressed at the fuel station to a pressure of greater than 3600 psig, 3700 psig, 3800 psig, 3900 psig, 4000 psig, 4500 psig, 5000 psig, 5500 psig, 6000 psig, 7000 psig, or 8000 psig. The pressure indicator (PI) and the mass indicator (MI) may be configured to measure and indicate the pressure and mass of the gas after it has been compressed and cooled at the fuel station.

The plurality of pipes may include an inlet pipe located between the fuel station and the fuel tank, and an outlet pipe located between the fuel tank and the natural gas pipeline. The fill receptacle, a first temperature transducer (TT1), a first pressure transducer (PT1), and a valve (e.g., a first gate valve or a cylinder valve) may be disposed along the inlet pipe. In some embodiments, the fill receptacle may be a gas dispenser that is configured to dispense gas from the fuel station to the fuel tank. The first temperature transducer (TT1) and the first pressure transducer (PT1) may be configured to measure the temperature and pressure of the gas entering the fuel tank. In some embodiments, the first temperature transducer (TT1) and the first pressure transducer (PT1) may be configured to measure the temperature and pressure of the gas flow along the inlet pipe, for example, between the fill receptacle and the valve (e.g., the first gate valve or the cylinder valve). The valve (e.g., the first gate valve or the cylinder valve) may be configured to control the mass flow rate of the gas entering the fuel tank.

A second temperature transducer (TT2), a second pressure transducer (PT2), and a plurality of valves (e.g., a second gate valve, the needle valve, the cylinder secondary valve, and the fill bleed valve) may be disposed along the outlet pipe. As shown in FIG. 11, the mass transducer (MT) may be disposed along the outlet pipe. The second temperature transducer (TT2) and the second pressure transducer (PT2) may be configured to measure the temperature and pressure of the gas exiting the fuel tank. In some embodiments, the second temperature transducer (TT2) and the second pressure transducer (PT2) may be configured to measure the temperature and pressure of the gas flow along the outlet pipe, for example, between the fuel tank and a valve (e.g., the second gate valve or the cylinder secondary valve). The second gate valve or the cylinder secondary valve may be configured to control the mass flow rate of the gas exiting the fuel tank.

The fuel tank can be filled with compressed gas from the fuel station/fill receptacle, by opening the first gate valve or the cylinder valve. When the fuel tank is being filled with compressed gas, the gas temperature of the fuel tank may increase due to heat of compression. To reduce the temperature and pressure rise from heat of compression, a portion of the heated gas can be removed from the fuel tank by opening at least one of the second gate valve, the needle valve, the cylinder secondary valve, and the fill bleed valve, and circulated back to the natural gas pipeline. The needle valve or the fill bleed valve may be configured to control the flow rate of the removed gas into the natural gas pipeline, since the gas pipeline may be at a low pressure and the partially filled fuel tank may be at a higher pressure. The portion of the as-heated gas that is removed from the fuel tank may be replaced with cooler ambient temperature gas from the inlet pipe. As previously described, the convective mixing of the cooler intake gas with the remaining heated gas in the fuel tank (coupled with substantially high incoming/outgoing mass flow rates) can reduce the gas temperature in the fuel tank, which can lead to improved capacity utilization of the fuel tank. The mass transducer (MT) may be configured to measure the mass flow rate of the gas along the outlet pipe, for example, between the fill bleed valve and the natural gas pipeline. The mass flow rate data from the mass transducer may be transmitted back to the fuel station in real-time or near real-time, so that the fuel station and/or a control module can control the cylinder valve and the cylinder secondary valve to modulate the mass flow rates of the gas into and out of the fuel tank. By controlling the flow of cool ambient temperature gas into the fuel tank and the flow of hot gas out of the fuel tank, the gas temperature in the fuel tank can be controlled, and the temperature and pressure rise due to heat of compression can be reduced.

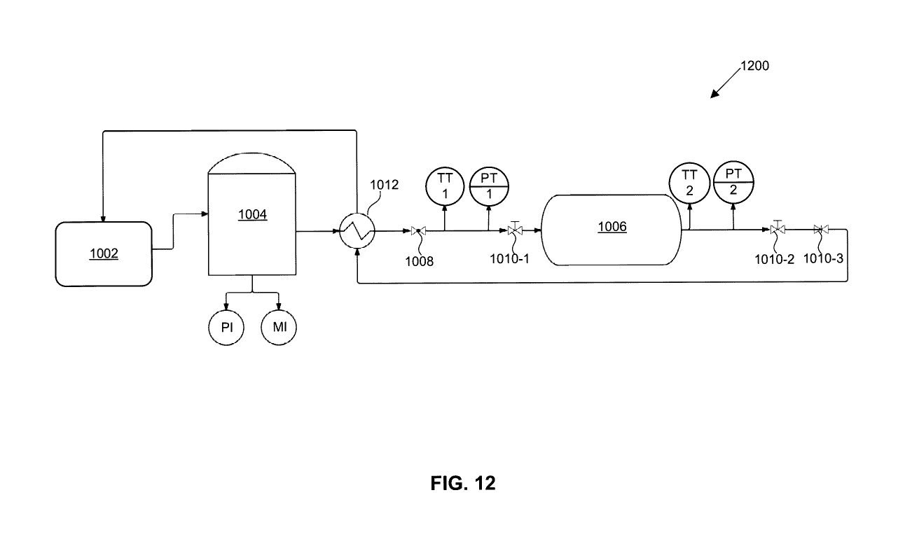

FIG. 12 illustrates a block diagram of an exemplary fuel refilling system 1200, in accordance with some other embodiments. The embodiment of FIG. 12 may be similar to the embodiment of FIG. 10 except for the following differences. In FIG. 12, a heat exchanger need not be located at the fuel station. Expanded fuel leaving the fuel tank can provide a method of chilling the incoming gas flow (via Joule-Thomson effect), further reducing temperature rise within the tank and reducing the mass removal requirements of the circulation system. As such, a heat exchanger 1012 may be located along the inlet pipe between the fuel station and the fill receptacle as a stand-alone component. In addition, the portion of the heated gas that is removed from the fuel tank may be passed through the heat exchanger before it is circulated to the natural gas pipeline. Accordingly, both the fuel station and the fuel tank can use a common heat exchanger, which can help to reduce costs.

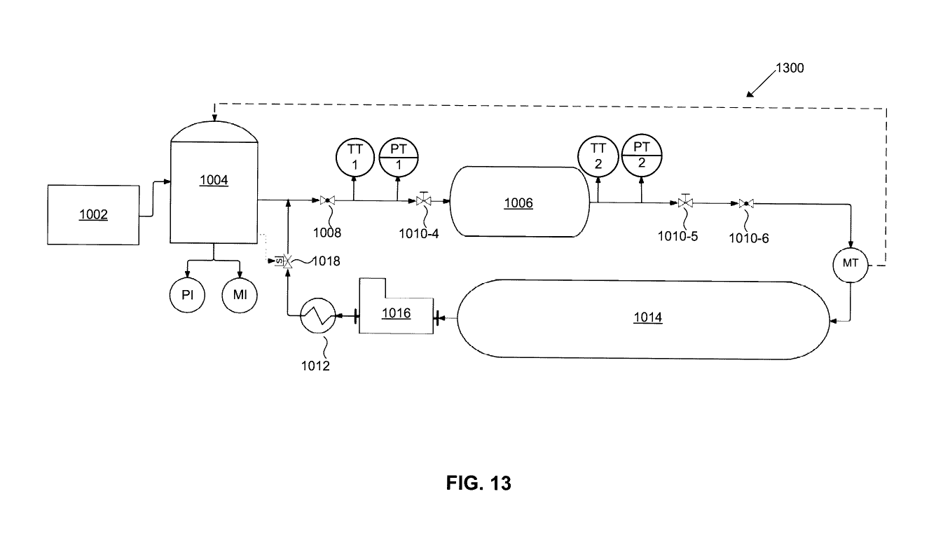

FIG. 13 illustrates a block diagram of an exemplary fuel refilling system 1300, in accordance with some other embodiments. The embodiment of FIG. 13 may be similar to the embodiment of FIG. 11 except for the following differences. In FIG. 13, the system may further include station gas storage 1014, a heat exchanger 1012, a circulation compressor 1016 or blower, and a solenoid valve 1018. The station storage may be connected to an end portion of the outlet pipe, and may be configured to store the heated gas that has been removed from the fuel tank. The heat exchanger, the circulation compressor or blower, and the solenoid valve may be disposed along a recirculation pipe connecting the station storage to the inlet pipe. The heated gas from the station storage may be passed through the heat exchanger (e.g., an air-cooled exchanger) to cool the gas.

The circulation compressor or blower may be configured to circulate the cooled gas back to the inlet pipe, for example at a juncture between the fuel station and the fill receptacle. The solenoid valve may be configured to either shut off or release the cooled gas from the circulation compressor or blower into the inlet pipe.

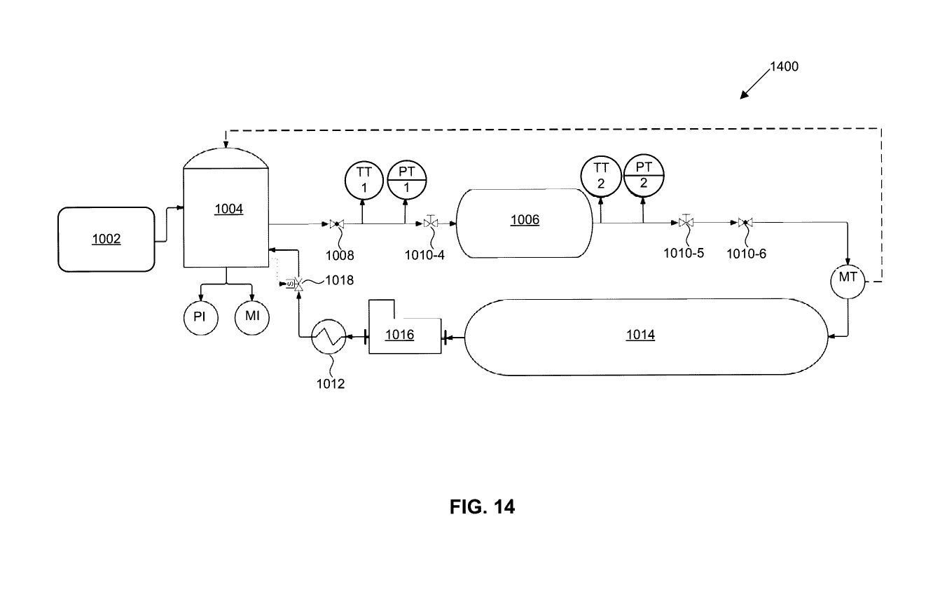

FIG. 14 illustrates a block diagram of an exemplary fuel refilling system 1400, in accordance with some other embodiments. The embodiment of FIG. 14 may be similar to the embodiment of FIG. 13 except for the following differences. In FIG. 14, the recirculation pipe may be connected to the fuel station 1004 instead of the inlet pipe. The circulation compressor 1016 or blower may be configured to circulate the cooled gas back to the fuel station. The fuel station may generate a signal for controlling the solenoid valve 1018. The signal may cause the solenoid valve to either shut off or release the cooled gas from the circulation compressor/blower back to the fuel station.

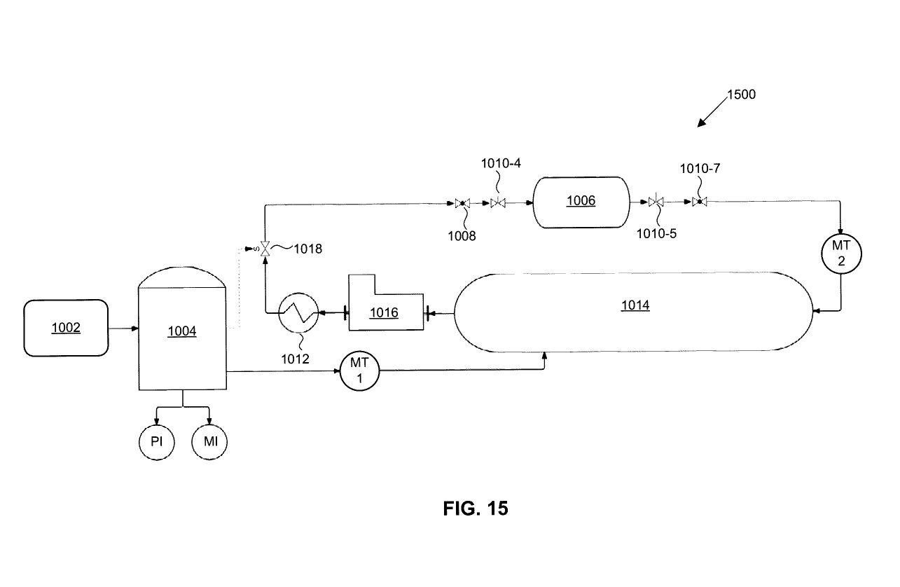

FIG. 15 illustrates a block diagram of an exemplary fuel refilling system, in accordance with some other embodiments. Referring to FIG. 15, a fuel refilling system 1500 may include a natural gas pipeline 1002, a fuel station 1004, a fuel tank 1006, a station storage 1014, a plurality of pipes, a fill receptacle 1008, a plurality of valves 1010, a heat exchanger 1012, a circulation pump 1016, a solenoid valve 1018, and a plurality of sensors. The plurality of valves may include a cylinder valve 1010-4, a cylinder secondary valve 1010-5, and a circulation valve 1010-7. The plurality of sensors may include a mass indicator (MI), a pressure indicator (PI), a first mass transducer (MT1), and a second mass transducer (MT2). The natural gas pipeline, the fuel station, the fuel tank, and the station storage may be in selective fluid communication via the plurality of pipes connected thereto. The plurality of pipes may comprise an inlet pipe and an outlet pipe. Each of the inlet pipe and the outlet pipe may be connected between the fuel tank and the station storage to form a loop. The circulation pump, the heat exchanger, the solenoid valve, the fill receptacle, and the cylinder valve may be disposed along the inlet pipe. The cylinder secondary valve, the circulation valve, and the second mass transducer (MT2) may be disposed along the outlet pipe.

Compressed gas from the fuel station may be provided to and stored in the station storage. The pressure indicator (PI) and the mass indicator (MI) may be configured to measure and indicate the pressure and mass of the compressed gas at the fuel station. The first mass transducer (MT1) may be configured to measure the mass flow rate of gas from the fuel station to the station storage. The circulation pump may be configured to draw gas from the station storage, and circulate the gas to the heat exchanger. The heat exchanger may be configured to remove heat from the compressed gas as it passes through the heat exchanger. The fuel station may generate a signal for controlling the solenoid valve. The signal may cause the solenoid valve to either shut off or release the cooled gas from the station storage to the fill receptacle. The fill receptacle may be a gas dispenser that is configured to dispense gas from the station storage to the fuel tank. The cylinder valve may be configured to control the mass flow rate of the gas entering the fuel tank. The cylinder secondary valve may be configured to control the mass flow rate of the gas exiting the fuel tank.

The fuel tank can be filled with compressed gas from the station storage/fill receptacle, by opening the cylinder valve. When the fuel tank is being filled with compressed gas, the gas temperature of the fuel tank may increase due to heat of compression. To reduce the temperature and pressure rise associated with heat of compression, a portion of the heated gas can be removed from the fuel tank by opening the cylinder secondary valve and the circulation valve, and circulated back to the station storage. The circulation valve may be configured to control the flow rate of the removed gas to the station storage, since the station storage and the fuel tank may have different gas pressures. The portion of the heated gas that is removed from the fuel tank may be replaced with cooler gas from the inlet pipe. As previously described, the convective mixing of the cooler intake gas with the remaining heated gas in the fuel tank can reduce the gas temperature in the fuel tank, which can lead to improved fuel tank capacity utilization.

The second mass transducer (MT2) may be configured to measure the mass flow rate of the gas along the outlet pipe, for example, between the circulation valve and the station storage. The mass flow rate data from the second mass transducer (MT2) may be transmitted back to the fuel station in real-time or near real-time, so that the fuel station and/or a control module can control the cylinder valve and the cylinder secondary valve to control the mass flow rates of the gas into and out of the fuel tank. By controlling the flow of cool gas into the fuel tank and the flow of hot gas out of the fuel tank, the gas temperature in the fuel tank can be controlled, and the temperature and pressure rise due to heat of compression can be reduced. As previously mentioned, the capacity utilization of the fuel tank can be improved/increased using the above method.

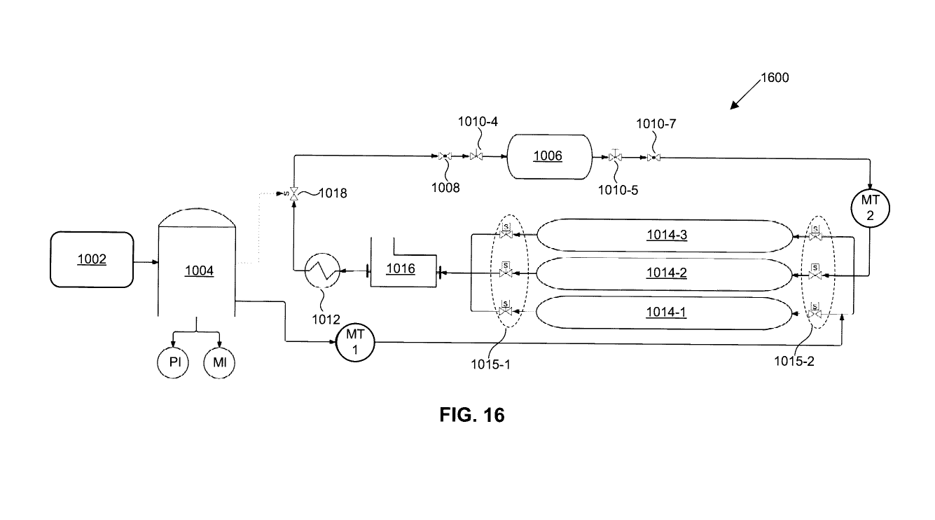

FIG. 16 illustrates a block diagram of an exemplary fuel refilling system 1600, in accordance with some other embodiments. The embodiment of FIG. 16 may be similar to the embodiment of FIG. 15 except for the following differences. In FIG. 15, the station storage 1014 may be provided in the form of a cascade storage bank. The cascade storage bank may comprise a low pressure storage tank 1014-1 for storing gas at a low pressure (e.g., approximately 1500 psig), a medium pressure storage tank 1014-2 for storing gas at a medium pressure (e.g., approximately 3000 psig), and a high pressure storage tank 1014-3 for storing gas at a high pressure (e.g., approximately 4500 psig). The gas that is removed from the fuel tank may be stored in one or more of the storage tanks. In some embodiments, a first portion of the gas from the fuel tank may be stored in the low pressure storage tank; a second portion of the gas from the fuel tank may be stored in the medium pressure storage tank; and a third portion of the gas from the fuel tank may be stored in the high pressure storage tank. In some embodiments, the first portion, second portion, and third portion of the gas may be substantially the same. In other embodiments, the first portion, second portion, and third portion of the gas may be substantially different. Alternatively, all station side storage vessels may be held at the same pressure, and distribution of mass across the storage vessels can be equal. Any mass ratios of the first portion, second portion, and third portion of the gas that is stored in the storage tanks may be contemplated.

As shown in FIG. 16, each of the storage tanks may include an inlet solenoid valve 1015-1 and an outlet solenoid valve 1015-2. The inlet solenoid valve may be disposed between the circulation valve and the corresponding storage tank. The outlet solenoid valve may be disposed between the corresponding storage tank and the circulation pump. For example, a first inlet solenoid valve may be disposed between the high pressure storage tank and the circulation valve, and a first outlet solenoid valve may be disposed between the high pressure storage tank and the circulation pump. Similarly, a second inlet solenoid valve may be disposed between the medium pressure storage tank and the circulation valve, and a second outlet solenoid valve may be disposed between the medium pressure storage tank and the circulation pump. Likewise, a third inlet solenoid valve may be disposed between the low pressure storage tank and the circulation valve, and a third outlet solenoid valve may be disposed between the low pressure storage tank and the circulation pump. The fuel station may generate signals for controlling the inlet solenoid valves and the outlet solenoid valves. The signals may cause the inlet solenoid valves to either shut off or release the gas from the fuel tank into the corresponding storage tank. The signals may also cause the outlet solenoid valves to either shut off or release the gas from the corresponding storage tank to the circulation pump. The solenoid valve between the heat exchanger and the fill receptacle may be configured to either shut off or release the cooled ambient temperature gas from the heat exchanger to the fill receptacle.

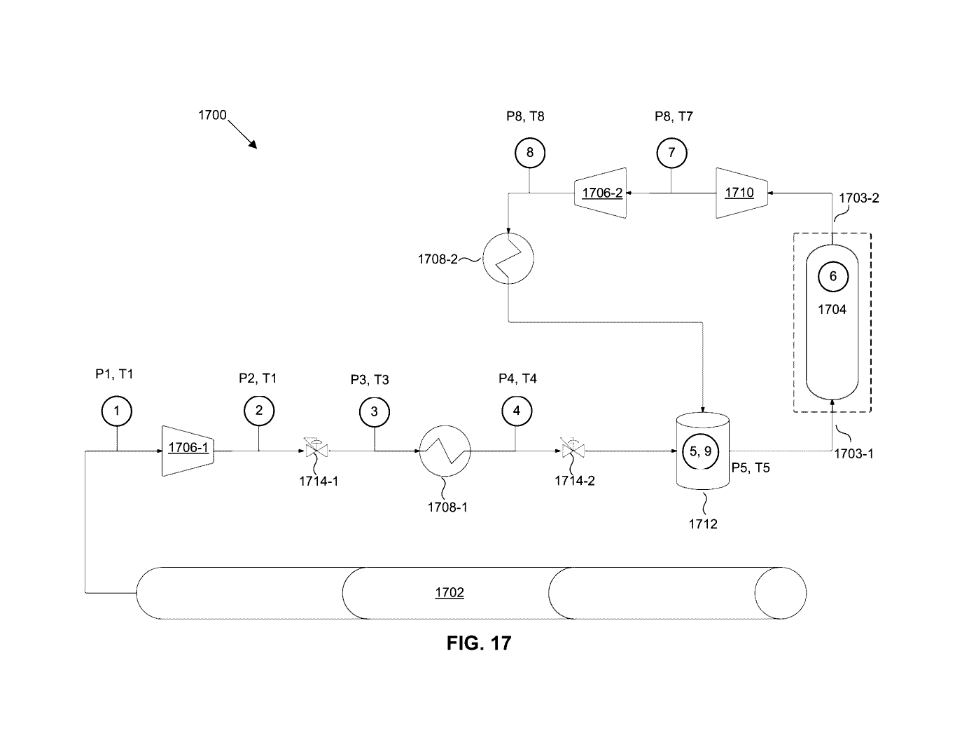

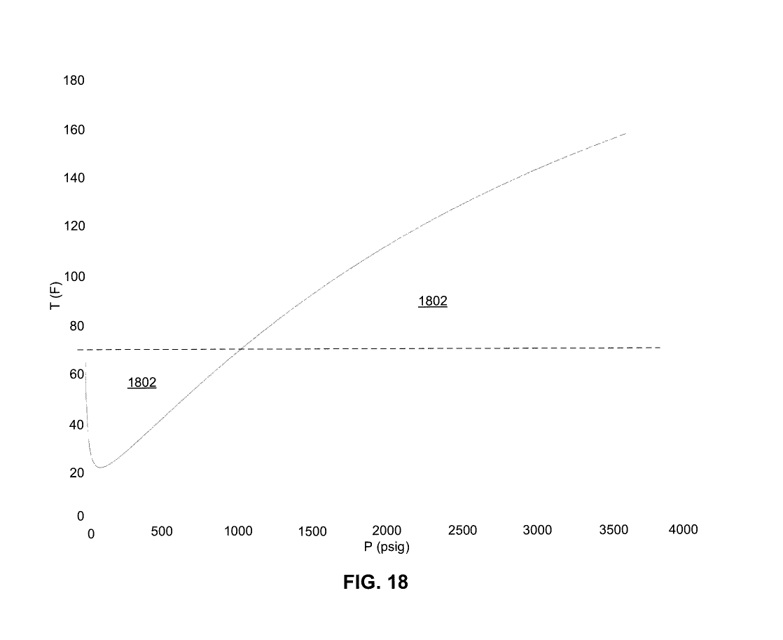

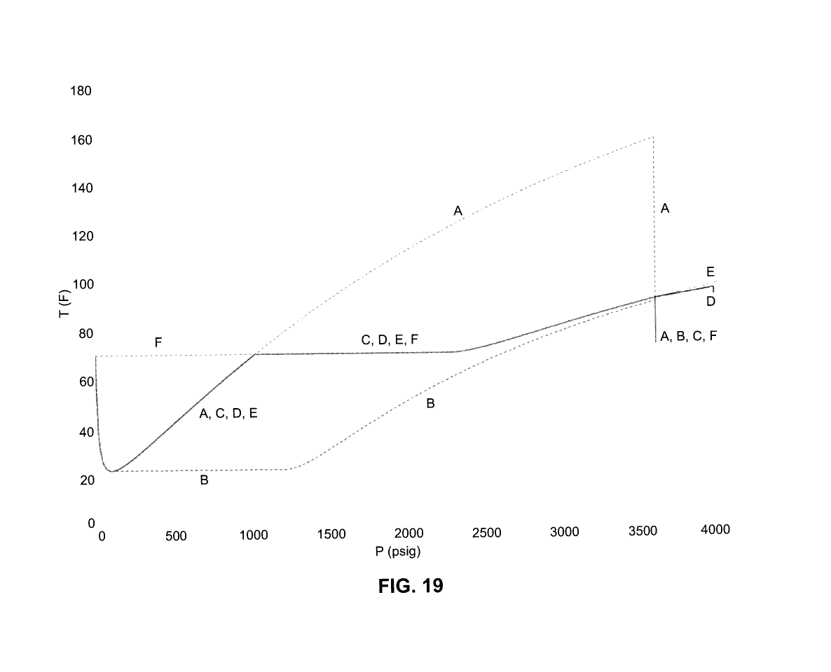

FIG. 17 illustrates a block diagram of an exemplary fuel refilling system, in accordance with some other embodiments. FIGS. 19, 20, 21, 22, 23, and 24 are plots illustrating different filling characteristics of the fuel refilling system of FIG. 17. FIG. 18 is a plot illustrating a filling characteristic for the fuel refilling system of FIG. 3. It should be noted that the values depicted in FIGS. 17, 18, 19, 20, 21, 22, 23, and 24 are merely exemplary, and that the system(s) can exhibit different behaviors depending on the input variables. For example, one or more input variables into the system(s) may influence, either directly or indirectly, one or more output results/values of the system(s). Any value for the input variables may be contemplated. Likewise, any output result/value may be contemplated (and obtained) by modifying the input variables.

Referring to FIG. 17, a fuel refilling system 1700 may comprise a natural gas pipeline 1702, a fuel tank 1704, a plurality of pipes 1703, a plurality of compressors 1706, a plurality of heat exchangers 1708, an expansion turbine 1710, a dispenser 1712, a plurality of gas regulators 1714, and a plurality of sensors. The plurality of compressors may include a main compressor 1706-1 and a circulation compressor 1706-2. The plurality of heat exchangers may include a main heat exchanger 1708-1 and a circulation heat exchanger 1708-2. The plurality of gas regulators may include an expansion regulator 1714-1 and a dispenser regulator 1714-2. The plurality of sensors may include a plurality of pressure sensors and temperature sensors located at different junctures in the fuel refilling system. The natural gas pipeline and the fuel tank may be in selective fluid communication via the plurality of pipes connected thereto.

The natural gas pipeline may be configured to transport natural gas (methane gas) at a low pressure (e.g., about 200 psig) and at ambient temperature (e.g., about 70 F). The gas may be drawn from the pipeline and directed to the main compressor. A first pressure sensor and a first temperature sensor may be configured to measure the pressure and temperature of the gas going into the main compressor. As shown in FIG. 17, the gas may enter the main compressor with a pressure P1 (e.g., about 200 psig) and temperature T1 (e.g., about 70 F). The main compressor may be configured to compress the gas. In some embodiments, the main compressor may have an efficiency of about 80%, less than 80%, or greater than 80%. It is noted that the main compressor can have an efficiency ranging anywhere between 0% and 100%. The compression of the gas increases the pressure of the gas and generates heat. The compressed gas may exit the main compressor at a pressure P2 (e.g., about 5000 psig) and a temperature T2 (e.g., about 658.4 F), as measured by a second pressure sensor and a second temperature sensor disposed at the outlet of the main compressor. The compressed gas is then regulated by the expansion regulator which causes the gas to expand and its pressure to drop to a pressure P3 (e.g., about 4500 psig), as measured by a third pressure sensor disposed at the exit of the expansion regulator. Since the expansion is regulated (i.e., not free rapid expansion), the enthalpy of the gas may be substantially the same before and after the expansion (i.e., h1=h2, where h1 is the enthalpy before expansion, and h2 is the enthalpy after expansion). The temperature T3 of the expanded gas may be for example about 657.6 F, as measured by a third temperature sensor at the exit of the expansion regulator. The temperature T3 of the expanded gas may be substantially the same as the temperature T2 of the compressed gas, since there is no change in enthalpy. The expanded gas is then passed through the main heat exchanger to cool the gas to a temperature T4 (e.g., about 78.3 F), as measured by a fourth temperature sensor disposed at the exit of the main heat exchanger. The pressure P4 of the cooled gas remains the same (e.g., about 4500 psig) after passing through the main heat exchanger, as measured by a fourth pressure sensor disposed at the exit of the main heat exchanger, since the heat removal process does not affect the gas pressure. The cooled and compressed gas is then regulated by the dispenser regulator, such that the mass flow rate of the gas to the dispenser is up to about 30 lb/min. The dispenser regulator also causes the gas to expand and its pressure to drop to a pressure P5 (e.g., about 3500 psig), as measured by a fifth pressure sensor disposed at the dispenser. Since the expansion is regulated (i.e., not free rapid expansion), the enthalpy of the gas may be substantially the same before and after the expansion (i.e., h4=h5, where h4 is the enthalpy before expansion, and h5 is the enthalpy after expansion). The temperature T5 of the expanded gas may be for example about 70 F, as measured by a fifth temperature sensor at the dispenser. The temperature T5 of the expanded gas may be substantially the same as the temperature T4 of the compressed gas, since there is no change in enthalpy.

The dispenser may be configured to provide the gas to the fuel tank via an inlet line 1703-1 connecting the dispenser to a first opening of the fuel tank. The fuel tank may have a volume of about 100 cubic feet. In some embodiments, the fuel tank may have a volume of less than 100 cu. ft., 90 cu. ft., 80 cu. ft., 70 cu. ft., 60 cu. ft., or 50 cu. ft. In some other embodiments, the fuel tank may have a volume greater than 100 cu. ft., 110 cu. ft., 120 cu. ft., 130 cu. ft., 140 cu. ft., or 150 cu. ft. When the fuel tank is completely filled with the gas (i.e., 100% full), the mass of the gas may be about 11.983 lb/cu. ft (based on methane at 3600 psig and 70 F). A sixth pressure sensor and a sixth temperature sensor may be disposed in the chamber of the fuel tank to measure the gas pressure and temperature as the fuel tank is being filled. When the fuel tank is being filled with compressed gas, the gas temperature of the fuel tank may increase due to heat of compression. To reduce the temperature and pressure effects from heat of compression, a portion of the heated gas can be removed from the fuel tank via a second opening in the fuel tank. An outlet line connects the second opening of the fuel tank to the expansion turbine. The expansion turbine may be configured to cause the compressed gas from the fuel tank to expand. In some embodiments, the expansion turbine may have an efficiency of about 80%, less than 80%, or greater than 80%. It is noted that the expansion turbine can have an efficiency ranging anywhere between 0% and 100%. The compressed gas from the fuel tank may drop to a pressure P7 (e.g., about 500 psig) after passing through the expansion turbine, as measured by a seventh pressure sensor disposed at the exit of the expansion turbine. A seventh temperature sensor disposed at the exit of the expansion turbine may be configured to measure a temperature T7 of the expanded gas. The temperature T7 may vary depending on the temperature and pressure of the gas that is being removed from the fuel tank. Next, the expanded gas is passed through the circulation compressor which compresses the gas to a pressure P8 (e.g., about 3600 psig), as measured by an eighth pressure sensor disposed at the exit of the circulation compressor. In some embodiments, the circulation compressor may have an efficiency of about 80%, less than 80%, or greater than 80%. It is noted that the circulation compressor can have an efficiency ranging anywhere between 0% and 100%. An eighth temperature sensor disposed at the exit of the circulation compressor may be configured to measure a temperature T8 of the compressed gas. The temperature T8 may vary, since it depends on the temperature T7 which is variable. Typically, the temperature T8 is higher than the temperature T7, since the temperature of the compressed gas increases due to heat of compression. The heated and compressed gas is then passed through the circulation heat exchanger to cool the gas. The cooled and compressed gas is then circulated back to the dispenser at a mass flow rate of up to about 110 lb/min, and having the pressure P5 (e.g., about 3600 psig) and the temperature T5 (e.g., about 70 F). In some embodiments, a ratio of the mass flow rates from (1) the circulation heat exchanger to the dispenser and (2) from the dispenser regulator to the dispenser, may be defined as X:Y, where X and Y may be any integer. In some embodiments, the ratio X:Y of the mass flow rates may be 3:1, 4:1, 5:1, or greater than 5:1. In some embodiments, the ratio X:Y of the mass flow rates may be 2:1 or less than 2:1. Any ratios of the mass flow rates may be contemplated. The ratios of the mass flow rates may be adjusted in real-time to induce varying rates of uniform or turbulent mixing of the cooler ambient temperature gas and the heated gas, such that the gas temperature can be distributed more evenly within the tank. The cooled and compressed gas is then recirculated back to the fuel tank via the inlet line, to replace the portion of the heated gas that has been removed from the fuel tank via the outlet line. As previously described, the convective mixing of the cooler intake gas with the remaining heated gas in the fuel tank (coupled with substantially high incoming/outgoing mass flow rates) can reduce the gas temperature in the fuel tank, which can increase the fuel tank capacity utilization.

FIG. 18 illustrates a plot of the internal fuel tank temperature T as a function of pressure P, for the fuel refilling system of FIG. 3 from empty to some percent-full. As previously described, the fuel refilling system 300 in FIG. 3 is a closed end (one-port) system. In other words, gas can only enter the fuel tank but cannot exit the fuel tank. In the system of FIG. 3, there is no heat removal mechanism to remove the temperature rise from heat of compression in the fuel tank as it is being filled. As a result, the gas cannot be removed from the system, and can only flow in one direction—i.e., from the fueling station to the fuel tank. The fuel temperature in the tank will rise due to heat of compression, which may ultimately lead to an under-filled condition.

As shown in FIG. 18, the temperature of the intake gas may be initially at an ambient temperature, for example about 70 F. When the empty or nearly empty fuel tank is filled with gas, the compressed gas undergoes rapid free expansion when it first enters the tank. Accordingly, the temperature of the gas will initially drop, for example from about 70 F to about 25 F due to the Joule-Thomson effect, although pressure is ever increasing. In FIG. 18, the low Joule-Thompson temperature of 25 F may be calculated based on a 70 F and 3600 psig input stream of pure methane. The temperature-pressure region below the initial ambient temperature (<70 F) may correspond to the Joule-Thomson region 1802. As the fuel tank is being filled with more gas, the density of the gas in the fuel tank becomes higher (i.e., the gas becomes more compressed), and there is less free expansion of the gas since the gas molecules are now closer together. The gas temperature in the fuel tank may rise beyond the ambient temperature at pressures above 1000 psig, due to heat of compression. The temperature-pressure region above the initial ambient temperature (>70 F) may correspond to the heat of compression region 1804. Due to the lack of a heat removal mechanism, the temperature of the gas in the fuel tank will continue to rise with increasing pressure. As shown in FIG. 18, when the gas pressure reaches about 3600 psig, the gas temperature may be for example about 155 F, which is substantially higher than the ambient temperature of about 70 F. The substantially higher temperature and lack of a heat removal mechanism may lower the capacity utilization of the fuel tank, since the capacity utilization is often limited by allowable temperature/structural limits of the fuel tank. Per the conditions of FIG. 18, only 78% of the fuel tank capacity is being utilized (commonly referred to as fill quality) if rated to 3600 psig and 70 F.

Next, the filling characteristics of certain exemplary methods will be described with reference to FIGS. 19, 20, 21, 22, 23, and 24. FIG. 19 illustrates plots of the internal fuel tank temperature as a function of pressure for various fuel refilling operations, in accordance with different embodiments of the invention. The plots in FIG. 19 may be associated with one or more of the exemplary fuel refilling systems previously described in FIGS. 1, 2A, 2B, 2C, 2D, 2E, 4, 5, 6, 8, 9, 10, 11, 12, 13, 14, 15, 16, and 17. The fuel refilling systems may be open end (two-port or multi-port) systems, in which fuel can enter and exit the fuel tank at the same time or at different times. As previously described, the convective mixing of the cooler intake gas with the remaining heated gas in the fuel tank can reduce the gas temperature in the fuel tank, which can lead to improved fuel tank capacity utilization.

In the example of FIG. 19, plot A may depict the temperature-pressure characteristics for a first cooling circulation loop that is activated at a predetermined mass flow rate after full heat of compression. Plot B may depict the temperature-pressure characteristics for a second cooling circulation loop that is activated at a lowest Joule-Thomson temperature with active control. Plot C may depict the temperature-pressure characteristics for a third cooling circulation loop that is activated at a predetermined threshold temperature. Plot D may depict the temperature-pressure characteristics for a fourth cooling circulation loop that is activated at a predetermined threshold temperature, and with added over-pressurization of about 10.4% (modeled from 3600 psig to 3975 psig). Plot E may depict the temperature-pressure characteristics for a fifth cooling circulation loop that is activated at a predetermined threshold temperature, and with added over-pressurization of about 12.3% (modeled from 3600 psig to 4043 psig). Plot F may depict the temperature-pressure characteristics for a sixth cooling circulation loop that is activated during a three-stage cascade design with active control.

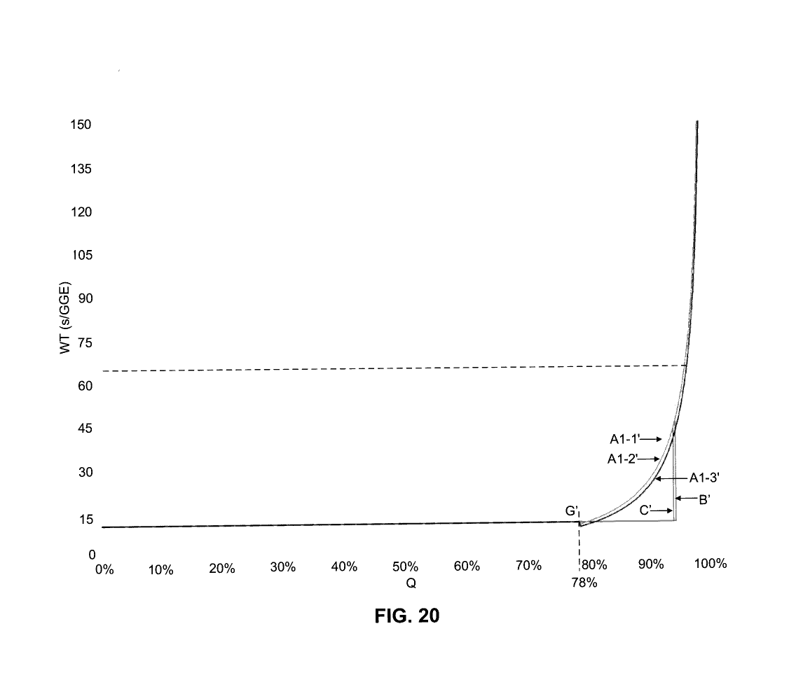

Referring to plot A, the fuel tank may be allowed to reach full heat of compression (e.g., temperature of about 155 F at about 3600 psig) before the first cooling circulation loop is activated. When the first cooling circulation loop is activated, a portion of the heated gas in the fuel tank may be removed from the tank, to be replaced with cooler intake gas. The mass flow rate of the heated gas leaving the fuel tank may vary depending on the rate of cooling desired. For example, as shown in plot A, when the gas pressure is at 3600 psig, a high mass flow rate (e.g., up to 100 lb/min) may result in a fast drop in temperature from 155 F to 70 F, since a large mass of heated gas in the fuel tank is rapidly replaced with cooler gas. Conversely, a low mass flow rate (e.g., 10 lb/min) may result in a slower drop in temperature from 155 F to 70 F (not explicitly shown in FIG. 19, but in FIG. 20 as A1-1′, A1-2′, and A1-3′).

Referring to plot B, the second cooling circulation loop is activated when the gas reaches its lowest Joule-Thomson temperature. In other words, the fuel tank does not reach full heat of compression before the second cooling circulation loop is activated. As the gas pressure in the tank increases, a portion of the heated gas in the fuel tank may be removed from the tank, to be replaced with cooler intake gas. By controlling the mass flow rates of the intake cooler gas and the outgoing heated gas in the second cooling circulation loop, the gas temperature can be controlled such that it does not substantially exceed the ambient temperature of 70 F. As shown in plot B, the gas temperature may reach only about 90 F when the gas pressure is about 3600 psig.

Referring to plot C, the third cooling circulation loop is activated when the gas reaches at a predetermined threshold temperature (e.g., the ambient temperature of about 70 F). In other words, the fuel tank does not reach full heat of compression before the third cooling circulation loop is activated. As the gas pressure in the tank increases, a portion of the heated gas in the fuel tank may be removed from the tank, to be replaced with cooler intake gas. By actively controlling the mass flow rates of the intake cooler gas and the outgoing heated gas in the second cooling circulation loop, the gas temperature can be controlled such that it does not substantially exceed the ambient temperature of 70 F. As shown in plot C, the gas temperature may reach only about 90 F when the gas pressure is about 3600 psig.

The fourth cooling circulation loop and the fifth cooling circulation loop may be similar to the third cooling circulation loop except for the following differences. The fourth cooling circulation loop may be configured to over-pressurize the fuel tank to about 3975 psig using, for example, a step pressure function. The fifth cooling circulation loop may be configured to over-pressurize the fuel tank to about 4043 psig using, for example, a ramp/variable pressure function. As shown in plot D, the gas temperature may be about 96 F when the gas pressure is about 3975 psig. As shown in plot E, the gas temperature may be about 98 F when the gas pressure is about 4043 psig. Unlike conventional over-pressurization methods, the over-pressurization steps in the fourth cooling circulation loop and the fifth cooling circulation loop do not significantly increase the gas temperature, since the heat of compression from the over-pressurization steps can be reduced by removing a portion of the heated gas and replacing it with cooler ambient temperature intake gas, and by modulating the mass inflow/outflow from the tank at substantially high flow rates. As previously mentioned, the over-pressurization of the fuel tank can increase the capacity utilization of the fuel tank.

Referring to plot F, the sixth cooling circulation loop is activated at the start of the gas refilling operation by using a three-stage cascade design with active control. The three-stage cascade design may include a low pressure storage tank that stores gas at about 1200 psig, a medium pressure storage tank that stores gas at about 2400 psig, and a high pressure storage tank that stores gas at about 3600 psig. It should be noted that the invention need not be limited to a three-stage cascade design. For example, the sixth cooling circulation loop may be activated at the start of the gas refilling operation by using any type of cascade storage regime, for example an n-stage cascade design, where n may be any integer greater than or equal to two. By actively controlling the mass flow rates of the intake cooler gas and the outgoing heated gas in the sixth cooling circulation loop, the gas temperature can be controlled such that it does not drop below or substantially exceed the ambient temperature of 70 F. As shown in plot F, the gas temperature may be about 70 F when the gas pressure is increased from a low pressure (e.g., 25 psig) to about 2300 psig. The gas temperature may be about 90 F when the gas pressure reaches about 3600 psig.

In the example plots of FIG. 19, the horizontal lines of constant temperature indicate that the gas temperature of the fuel tank is being actively controlled via the modulation of flow rates in the circulation loop. However, in some instances, once a flow rate reaches a predetermined maximum flow rate and saturates, some of the temperature control may be lost, which may cause the gas temperature to increase slightly above the control temperature. In some embodiments, the control module may be configured to monitor and adjust the mass flow rates to avoid flow rate saturation of the circulation loop. The mass flow rates may be adjusted, for example, based on one or more predetermined flow rate saturation limits. The flow rate saturation limits may be predefined by a user. Alternatively, the flow rate saturation limits may be determined in real-time by the control module based on mass flow rate data collected by one or more mass flow sensors. It is noted that without the flow rate saturation limits, the circulation flow rate may continue to increase so as to maintain a constant gas temperature of the increasing mass within the fixed volume of the fuel tank. Eventually, the circulation flow may exceed a practical flow rate beyond which the system is capable of handling. For example, one or more valves may fail when the circulation flow exceeds a practical flow rate. Accordingly, component failure of the circulation loop can be prevented by setting flow rate saturation limits that are calculated by a system controller. The system controller may be implemented using one or more processors in the control module. Alternatively, the system controller may be a user (e.g., an engineer) or group of users using the control module, and who may be responsible for calculating the flow rate saturation limits and determining when component failure may occur (as well as the associated safety factors).

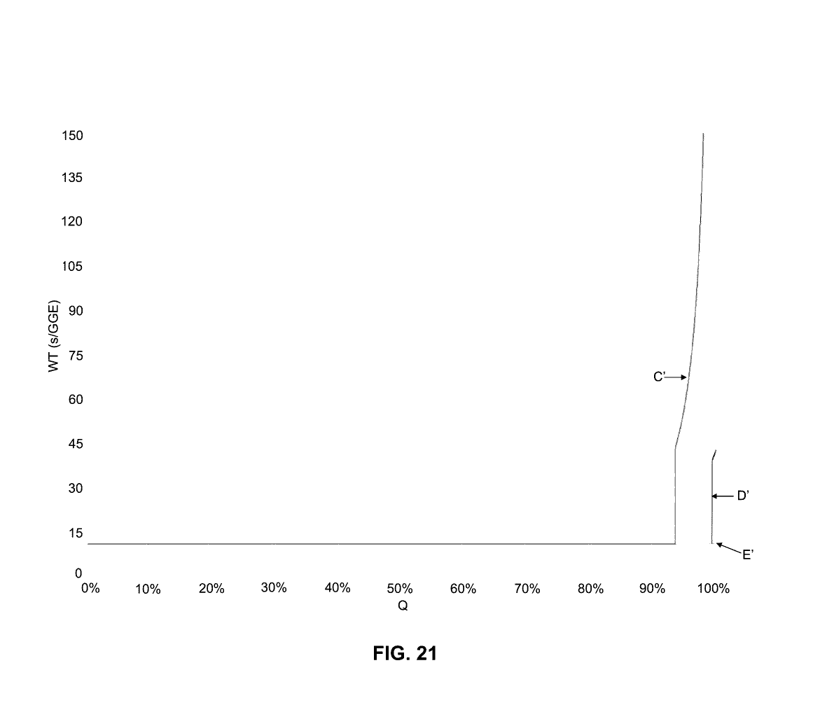

FIGS. 20 and 21 illustrate plots of the specific refilling wait time WT as a function of fill quality Q for the fuel refilling operations depicted in FIG. 19. In addition, FIG. 20 includes the specific wait time—fill quality plot for the fuel refilling system of FIGS. 3 and 18 as a comparison. FIG. 20 further includes the specific wait time—fill quality plots for the first cooling circulation loop (associated with plot A) in FIG. 19 at different mass flow rates.

Referring to FIGS. 20 and 21, plot A1-1′ depicts the specific wait time—fill quality characteristics for a cooling circulation loop that is activated at a mass flow rate (e.g., up to about 100 lb/min) after full heat of compression. Plot A1-2′ depicts the specific wait time—fill quality characteristics for a cooling circulation loop that is activated at a mass flow rate (e.g., up to about 110 lb/min) after full heat of compression. Plot A1-3′ depicts the specific wait time—fill quality characteristics for a cooling circulation loop that is activated at a mass flow rate (e.g., up to about 120 lb/min) after full heat of compression. Plot B′ depicts the specific wait time—fill quality characteristics for a cooling circulation loop that is activated at a lowest Joule-Thomson temperature with active control (corresponding to the second cooling circulation loop of FIG. 19). Plot C′ depicts the specific wait time—fill quality characteristics for a cooling circulation loop that is activated at a predetermined threshold temperature (corresponding to the third cooling circulation loop of FIG. 19). Plot D′ depicts the specific wait time—fill quality characteristics for a cooling circulation loop that is activated at a predetermined threshold temperature, and with added over-pressurization from 3600 psig to 3975 psig (corresponding to the fourth cooling circulation loop of FIG. 19). Plot E′ depicts the specific wait time—fill quality characteristics for a cooling circulation loop that is activated at a predetermined threshold temperature, and with added over-pressurization from 3600 psig to 4043 psig (corresponding to the fifth cooling circulation loop of FIG. 19). Plot G′ depicts the specific wait time—fill quality characteristics for a fuel refilling operation that does not have a cooling circulation loop (e.g., corresponding to the example of FIGS. 3 and 18).

Referring to plot G′ in FIG. 20, the capacity utilization of a fuel tank that does not have a cooling circulation loop may be limited to a capacity utilization of about 78% with a filling wait time of about 11 seconds per gasoline gallon equivalent (s/GGE), using a mass flow rate of about 30 lb/min. In contrast, the capacity utilization of a fuel tank with the different cooling circulation loops can be increased to more than 90%. Referring to plots B′ and C′, the capacity utilization of a fuel tank can be increased to about 92% without increasing the wait time, using the corresponding cooling circulation loops. In contrast, the filling wait times for the cooling circulation loops in plots A1-1′, A1-2′, and A1-3′ may increase exponentially at filling capacities above 78%, due to (1) pressure saturation and (2) decreasing temperature delta between the intake gas and the removed gas. As shown in plots A1-1′, A1-2′, A1-3′, B′, and C′, the wait times for those cooling circulation loops may increase to about 45 s/GGE when the capacity utilization reaches about 93%. In practice, it would require an infinitely long time to achieve 100% capacity utilization (or fill quality) with the fuel tank at the ambient temperature of 70 F and a final pressure of 3600 psig, since the convective mixing/cooling process is governed by exponentials with asymptotic behavior, as seen in FIG. 17. That is, as the system approaches close to 100% fill quality, the time required for minute changes in fill quality and temperature increases exponentially. As a result, depending on efficiency and economic considerations, there may be a compromise between filling wait time and capacity utilization for the above cooling circulation loops.

To increase the capacity utilization of the fuel tank without substantially increasing the filling wait time, over-pressurization steps may be incorporated into the cooling circulation loops.

For example, referring to plot D′ in FIG. 21, the capacity utilization of a fuel tank can be increased to about 97% without increasing the wait time, by using the fourth cooling circulation loop of FIG. 19. Similarly, referring to plot E′ in FIG. 21, the capacity utilization of a fuel tank can be increased to about 99% without increasing the wait time, by using the fifth cooling circulation loop of FIG. 19. As previously described, the fuel tank can be over-pressurized to 3975 psig using the fourth cooling circulation loop, and to 4043 psig using the fifth cooling circulation loop. In particular, the fourth cooling circulation loop includes a high-pressure (HP) boost to step up from a 3600 psig to a 3975 psig inlet gas stream when pressure saturation would occur. The high-pressure (HP) boost may be configured to eliminate a pressure discontinuity occurring at around 94% Fill Quality. The fifth cooling circulation loop includes a variable high-pressure (VHP) boost to ramp up from a 3600 psig to a 4043 psig inlet gas stream when pressure saturation would occur. The variable high-pressure (VHP) boost may be configured to eliminate a pressure discontinuity occurring at around 94% and 99% Fill Quality. A pressure discontinuity is a non-continuous change in pressure during the filling operation. A pressure discontinuity occurs when the fuel tank pressure is substantially identical to the flow inlet pressure and cannot be raised any higher. At this point, the circulation loop is also running at a maximum saturation flow rate, which leads to a systematic change in overall control because the gas temperature continues to drop. The control module may then generate a signal causing the main compressor (which may have a typical flow rate of about 30 lb/min) to step down in flow rate. This step-down in flow rate may be undesirable because it increases energy consumption, cost, and fill wait times.

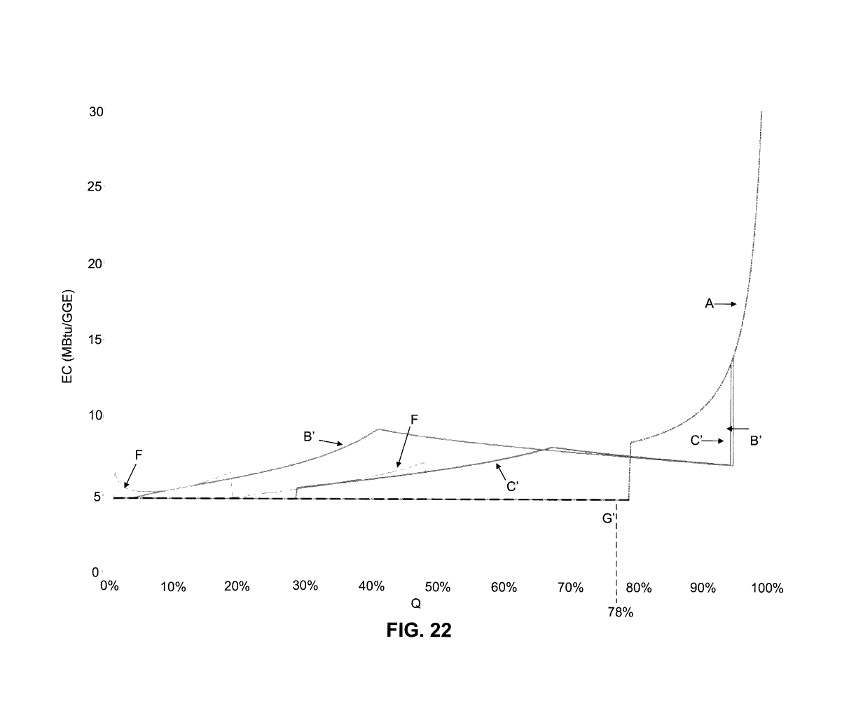

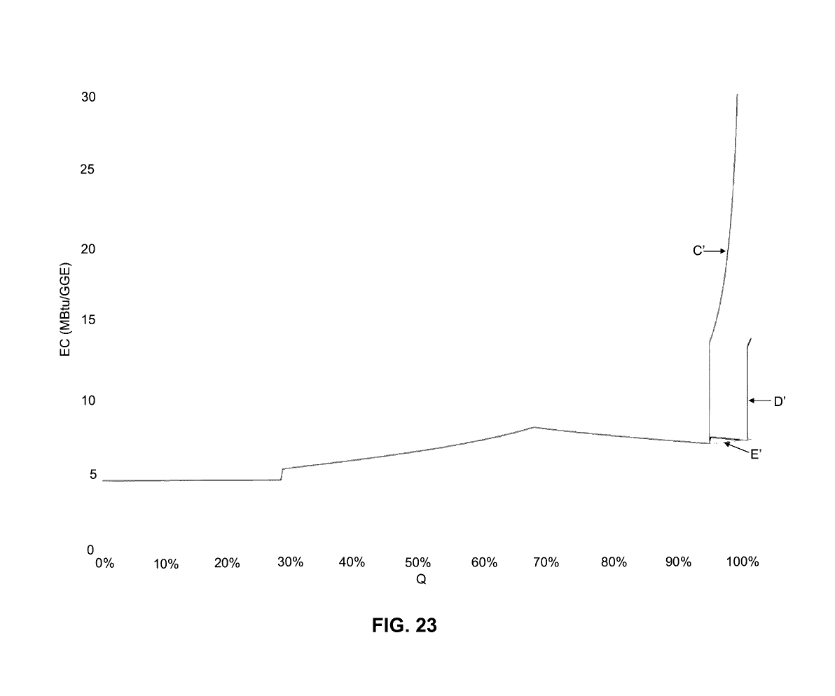

FIGS. 22 and 23 illustrate plots of the operational energy per gasoline gallon equivalent EC (MBtu/GGE) as a function of fill quality Q for the fuel refilling operations depicted in FIG. 19. In addition, FIG. 22 includes the specific operational energy (MBtu/GGE)—fill quality plot for the fuel refilling system of FIGS. 3 and 18 as a comparison. The specific operational energy is also a measure of the specific electrical energy cost per GGE, and is indicative of the cost of operating a given system.

Referring to FIGS. 22 and 23, plot A depicts the specific operational energy—fill quality characteristics for a cooling circulation loop that is activated at a predetermined mass flow rate (e.g., up to about 100 lb/min, up to about 110 lb/min, or up to about 120 lb/min) after full heat of compression. Plot B′ depicts the specific operational energy—fill quality characteristics for a cooling circulation loop that is activated at a lowest Joule-Thomson temperature with active control (corresponding to the second cooling circulation loop of FIG. 19). Plot C′ depicts the specific operational energy—fill quality characteristics for a cooling circulation loop that is activated at a predetermined threshold temperature (corresponding to the third cooling circulation loop of FIG. 19). Plot D′ depicts the specific operational energy—fill quality characteristics for a cooling circulation loop that is activated at a predetermined threshold temperature, and with added over-pressurization from 3600 psig to 3975 psig (corresponding to the fourth cooling circulation loop of FIG. 19). Plot E′ depicts the specific operational energy—fill quality characteristics for a cooling circulation loop that is activated at a predetermined threshold temperature, and with added over-pressurization from 3600 psig to 4043 psig (corresponding to the fifth cooling circulation loop of FIG. 19). Plot G′ depicts the specific operational energy—fill quality characteristics for a fuel refilling operation that does not have a cooling circulation loop (e.g., corresponding to the example of FIGS. 3 and 18).

Referring to plot G′ in FIG. 22, a fuel tank that does not have a cooling circulation loop may be limited to a capacity utilization of about 78% having a specific operational energy of about 5 MBtu/GGE, using a mass flow rate of about 30 lb/min. In contrast, a fuel tank having the different exemplary cooling circulation loops may have a specific operational energy that is greater than 5 MBtu/GGE at a capacity utilization of about 78%, due to the additional costs incurred by the further compression/cooling steps and high mass flow rates. It should be noted that the capacity utilization of a fuel tank having the different cooling circulation loops can be increased to greater than 78%, but with higher specific operational energies (i.e., higher operating costs). For example, referring to plots A, B′ C′, D′ and E′ in FIGS. 22 and 23, the capacity utilization of a fuel tank with the different cooling circulation loops can be increased to more than 90%, but with specific operational energies ranging from about 7 MBtu/GGE to about 30 MBtu/GGE. The exponential increase in costs is due to the exponential increase in filling wait times which have been described in FIGS. 20 and 21. As previously mentioned, the exponential increase in filling wait times (and costs) is due to (1) pressure saturation and (2) decreasing temperature delta between the intake gas and the removed gas. In practice, it would require an infinitely long time to achieve 100% capacity utilization (or fill quality) with the fuel tank at the ambient temperature of 70 F and a final pressure of 3600 psig, since the convective mixing/cooling process is governed by exponentials with asymptotic behavior, as seen in FIG. 17. That is, as the system approaches close to 100% fill quality, the time (and associated costs) required for minute changes in fill quality and temperature increases exponentially. As a result, depending on efficiency and economic considerations, there may be a compromise between filling wait time, specific operational energy and capacity utilization for the above cooling circulation loops.

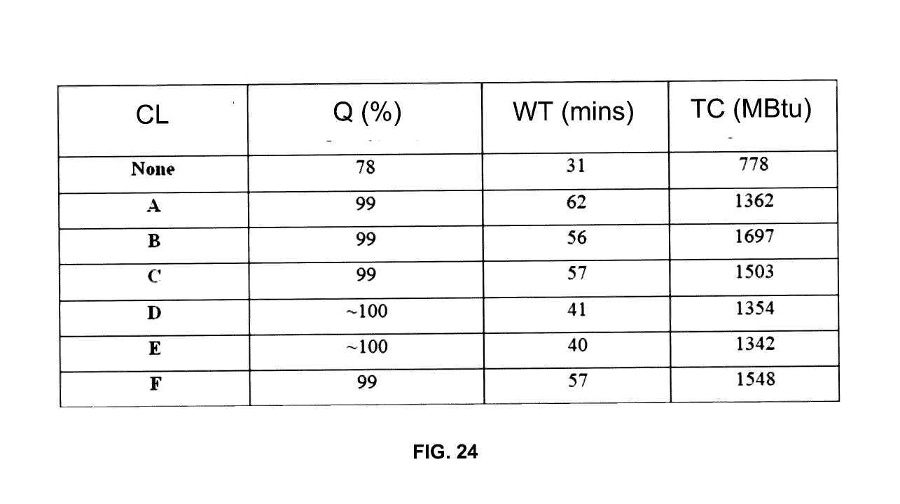

FIG. 24 depicts a table summarizing the fill quality Q (capacity utilization), total wait times WT, and total energy usage TC for refilling operations using the different cooling circulation loops CL in FIGS. 20, 21, 22, and 23, and for a refilling operation that does not use a cooling circulation loop. As shown in FIG. 24, for a refueling operation that does not use any cooling circulation loop, the fill quality may be limited to 78% with a wait time of 31 mins and an energy usage of 778 MBtu. In contrast, the refilling operations using the different cooling circulation loops can achieve a fill quality approximately equal to 100%, although with increased wait times and higher energy usage. For example, the cooling circulation loop A can enable a fill quality of 99% with a wait time of 62 mins and an energy usage of 1362 MBtu; the cooling circulation loop B can enable a fill quality of 99% with a wait time of 56 mins and an energy usage of 1697 MBtu; the cooling circulation loop C can enable a fill quality of 99% with a wait time of 57 mins and an energy usage of 1503 MBtu; the cooling circulation loop D can enable a fill quality of 100% with a wait time of 41 mins and an energy usage of 1354 MBtu; the cooling circulation loop E can enable a fill quality of 100% with a wait time of 40 mins and an energy usage of 1342 MBtu; and the cooling circulation loop F can enable a fill quality of 99% with a wait time of 57 mins and an energy usage of 1548 MBtu. Accordingly, the fill quality (capacity utilization) of the fuel tank can be substantially increased/improved, by using one or more of the above cooling circulation loops during the refilling operation. It should be noted that the tabulated results in FIG. 24 are specific to the parameters of FIG. 17, with an ambient temperature of 70 F and a maximum flow rate ratio of 11:3.

The systems, apparatuses, and methods for reducing temperature and pressure rise due to heat of compression and/or increasing capacity utilization of a fuel tank associated with fuel introduction or filling described above and herein are described as examples only. The systems, apparatuses, and methods can be combined and/or varied in many ways to reduce temperature and pressure rise associated with heat of compression and/or to increase capacity utilization of a fuel tank associated with fuel introduction or filling without departing from the scope of the present disclosure.

While preferred embodiments of the present disclosure have been shown and described herein, it will be obvious to those skilled in the art that such embodiments are provided by way of example only. Numerous variations, changes, and substitutions will now occur to those skilled in the art without departing from the scope of the present disclosure. It should be understood that various alternatives to the embodiments of the present disclosure described herein may be employed in practicing the inventions of the present disclosure. It is intended that the following claims define the scope of the invention and that methods and structures within the scope of these claims and their equivalents be covered thereby.

What is claimed is:

1. A fuel refilling system comprising:
a fueling station, a fuel tank, and a recirculation module in selective fluid communication with one another, wherein the fuel tank is configured to be filled with a fuel provided by the fueling station; and
a control module configured to generate one or more signals for controlling flow rates of the fuel into and out of the fuel tank, so as to remove and direct a first portion of heated fuel from the fuel tank to the recirculation module, and replace the first portion of heated fuel that is removed from the fuel tank with incoming cooler fuel received from the fueling station and/or the recirculation module.

2. The fuel refilling system of claim 1, wherein a capacity utilization of the fuel tank is increased as a result of temperature reduction within the fuel tank caused by convective mixing of the incoming cooler fuel with a remaining portion of the heated fuel.

3. The fuel refilling system of claim 1, wherein the fuel includes compressed natural gas (CNG), and wherein the fueling station is selected from the group consisting of a direct fill CNG station and a cascade CNG station.

4. The fuel refilling system of claim 1, wherein the fueling station, the fuel tank, and the recirculation module are in selective fluid communication with one another in a closed loop configuration.

5. The fuel refilling system of claim 1, wherein the recirculation module includes a heat exchanger configured to cool the first portion of heated fuel.

6. The fuel refilling system of claim 5, wherein the recirculation module includes a compressor configured to compress the cooled first portion of fuel, and wherein the recirculation module is configured to direct the compressed and cooled first portion of fuel to the fueling station and/or the fuel tank.

7. The fuel refilling system of claim 1, wherein the control module is configured to generate the one or more signals based on sensing data collected by a plurality of sensors located at different junctures of the fuel refilling system.

8. The fuel refilling system of claim 7, wherein the plurality of sensors comprise mass flow sensors, temperature sensors, and/or pressure sensors.

9. The fuel refilling system of claim 1, wherein the fuel refilling system comprises (1) one or more inlet pipes leading into the fuel tank and (2) an outlet pipe leading out of the fuel tank, and wherein the one or more signals comprise (1) a first signal that causes one or more inlet flow control valves along the one or more inlet pipes to open to a first degree, and (2) a second signal that causes an outlet flow control valve along the outlet pipe to open to a second degree.

10. The fuel refilling system of claim 9, wherein the one or more inlet pipes include (i) a first inlet pipe connecting the fuel tank to the fueling station and (ii) a second inlet pipe connecting the fuel tank to the recirculation module.

11. The fuel refilling system of claim 10, wherein the incoming cooler fuel is directed to the fuel tank (i) from the fueling station through the first inlet pipe, and/or (ii) from the recirculation module through the second inlet pipe.

12. The fuel refilling system of claim 9, wherein the outlet pipe connects the fuel tank to the recirculation module.

13. The fuel refilling system of claim 12, wherein the first portion of heated fuel is removed from the fuel tank and directed to the recirculation module through the outlet pipe.

14. The fuel refilling system of claim 9, wherein the first degree and the second degree are different.

15. The fuel refilling system of claim 14, wherein the first degree and the second degree are dynamically adjustable in order to vary incoming and outgoing fuel flow rates to/from the fuel tank, such that the fuel tank is capable of being filled within a predetermined time period, while controlling and/or reducing temperature rise due to heat of compression in the fuel tank during the filling.

16. The fuel refilling system of claim 9, wherein the second signal is generated when one or more temperature sensors detect a temperature of the fuel in the fuel tank exceeding a predetermined threshold temperature.

17. The fuel refilling system of claim 16, wherein the predetermined threshold temperature corresponds to a Joule-Thomson temperature achieved within the fuel tank.

18. The fuel refilling system of claim 9, wherein the first degree and the second degree are adjustable in order to generate forced convective mixing of the incoming cooler fuel with the remaining portion of the heated fuel, so as to increase a level of turbulence of the fuel mixture within the fuel tank.

19. A method of filling a fuel tank, comprising:
configuring the fuel tank, a fueling station, and a recirculation module to be in selective fluid communication with one another, wherein the fuel tank is configured to be filled with a fuel provided by the fueling station; and
generating, via a control module with aid of a processor, one or more signals for controlling flow rates of the fuel into and out of the fuel tank, to thereby (1) remove and direct a first portion of heated fuel from the fuel tank to the recirculation module, and (2) replace the first portion of heated fuel that is removed from the fuel tank with incoming cooler fuel from the fueling station and/or the recirculation module.

20. A non-transitory computer-readable medium with instructions stored thereon that, when executed by a control module with aid of a processor, causes the control module to perform a method of filling a fuel tank, the method comprising:
configuring the fuel tank, a fueling station, and a recirculation module to be in selective fluid communication with one another, wherein the fuel tank is configured to be filled with a fuel provided by the fueling station; and
generating one or more signals for controlling flow rates of the fuel into and out of the fuel tank, to thereby (1) remove and direct a first portion of heated fuel from the fuel tank to the recirculation module, and (2) replace the first portion of heated fuel that is removed from the fuel tank with incoming cooler fuel from the fueling station and/or the recirculation module.
